(19) United States
(12) Patent Application Publication
(10) Pub. No.: US 2007/0063147 A1
(43) Pub. Date: Mar. 22, 2007

(54) Doping device

(75) Inventors: Shunpei Yamazaki, Setagaya (JP); Junichi Koezuka, Atsugi (JP); Hiroto Shinoda, Atsugi (JP); Osamu Nakamura, Atsugi (JP); Atsuo Isobe, Atsugi (JP); Tetsuji Yamaguchi, Atsugi (JP); Hiromichi Godo, Atsugi (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 11/148,287

(22) Filed: Jun. 9, 2005

(30) Foreign Application Priority Data
Jun. 14, 2004 (JP) 2004-176230

(51) Int. Cl. H01J 27/00; H01J 7/24; H05B 31/26

(52) U.S. Cl. 250/424; 315/111.21

(57) ABSTRACT

According to the present invention, a manufacturing device of a semiconductor device provided with a device for uniformly doping with an impurity element a large area substrate capable of multiple patterns for the purpose of mass-production is provided. The present invention has a feature that a cross section of an ion current is to be a linear shape or a rectangle, and the large area substrate is moved in a direction perpendicular to a longitudinal direction of the ion current while keeping the large area substrate inclined at a predetermined tilt angle θ to the ion current. In this invention, an incident angle of an ion beam is adjusted as changing the tile angle θ. By making the large area substrate inclined to a horizontal plane, the width of the longitudinal direction of the ion current can be shortened than the length of a side of the substrate.

### BACKGROUND OF THE INVENTION

1. Field of the Invention

The present invention relates to a doping device used when a semiconductor device having a circuit constituted by a thin film transistor (hereinafter referred to as a TFT) is manufactured. Specifically, the invention relates to an ion doping device having a preferable structure for treating a large area substrate.

In this specification, a semiconductor device indicates general devices which functions by utilizing semiconductor properties, and includes all of electro-optical devices, semiconductor circuits, and electric apparatuses.

2. Description of Related Art

In manufacturing a semiconductor integrated circuit using a silicon wafer, a method for forming an impurity region by doping a semiconductor with an impurity element imparting n-type or p-type is known. Doping for separating mass and charge ratio of ions is referred to as ion implantation and widely used when manufacturing a semiconductor integrated circuit. In addition, doping for injecting an impurity ion as an ion current (ion shower) into a semiconductor by generating plasma including an impurity element and accelerating the impurity ion in the plasma with high voltage is referred to as ion doping or plasma doping, and widely used in a manufacturing process of a liquid crystal display using a glass substrate or the like.

In manufacturing an electric apparatus having a semiconductor circuit, a multiple pattern by which plural devices are cut from one mother glass instead of using a silicon wafer is employed for efficient mass-production. The size of a mother glass substrate is increased from 300×400 mm of the first generation in the early 1990s to 680×880 mm or 730×920 mm of the fourth generation in 2000. Furthermore, manufacturing technique has been developed so that a large number of devices, typically, display panels can be obtained from one substrate.

In the conventional doping device, a substrate (or a wafer) is revolved so as to make the distribution of ion implantation uniform. When the substrate grows further in size hereafter, the conventional doping device is thought to have a disadvantage for mass production in that a mechanism for revolving a large area substrate becomes a large scale.

In the conventional doping device, a substrate revolves around an inclined axis, thus ion injection distribution is arranged concentrically. Furthermore, in the conventional doping device, since the size of the substrate is limited so as to fit into an outer circumference of an ion current, there is a problem of wasting ion showers, which is inefficient.

The present applicant shows a linear doping device in which a substrate is moved without being revolved in Patent Document 1.

Patent Document 1: Japanese Patent Laid-Open No. Hei 10-162770

The present applicant also shows a doping device in which a substrate is relatively moved using a laser beam in Patent Document 2.

Patent Document 2: Japanese Patent Laid-Open No. 2001-210605

### SUMMARY OF THE INVENTION

### Problem to be Solved by the Invention

The invention provides a manufacturing device of a semiconductor device provided with a device for doping an impurity element uniformly using a large area substrate from which plural panels can be manufactured for the purpose of mass-production.

### MEANS TO SOLVE THE PROBLEM

The present invention has a feature that a cross section of an ion current is to be a linear shape or a rectangle, and a large area substrate is moved in a direction perpendicular to the longitudinal direction of the ion current while keeping the large area substrate inclined at a predetermined tilt angle θ to the ion current. As the large area substrate, a substrate having a size of 600 mm×720 mm, 680 mm×880 mm, 1000 mm×1200 mm, 1100 mm×1250 mm, 1150 mm×1300 mm, or more are used. In the invention, the incident angle of an ion beam is regulated by changing the tilt angle θ. By making the large area substrate inclined to a horizontal plane, the width of the ion current in the longitudinal direction can be shortened than the length of one side of the substrate.

A structure of the invention disclosed in this specification is a doping device comprising a means for generating an ion current with a cross section having a linear shape or a rectangle, a means for irradiating with the ion current, and a position control means for moving a substrate to be treated for one direction while keeping the substrate surface inclined to a perpendicular, wherein the inclined substrate to be treated which is moving, is irradiated with the ion current.

In the doping device, a substrate carry-in chamber and a substrate carry-out chamber are connected, and the substrate carry-in chamber and the substrate carry-out chamber are provided so as to face each other while sandwiching the doping device therebetween. A substrate stage of the doping chamber preferably includes an angle adjustment function and a substrate transport function. In addition, a means for heating the substrate may be provided in the doping chamber.

A structure of the invention disclosed in this specification is a doping device in which a substrate carry-in chamber, a doping chamber, and a substrate carry-out chamber are arranged in series, wherein the doping chamber includes a means for generating an ion current with a cross section having a linear shape or a rectangle and a substrate position control means for moving the substrate to be treated in one direction while keeping the substrate surface inclined to a perpendicular, and the substrate to be treated which moves from the substrate carry-in chamber to the substrate carry-out chamber through the doping chamber in one direction is irradiated with the ion current.

A substrate transfer robot is provided for the substrate carry-in chamber or the doping device. A mechanism for freely changing a robot holding position for holding the substrate in a horizontal position or an inclined position may be given.

When the large area substrate is transported at an inclined position, an occupied floor area (foot print) of a substrate can be smaller than that of a conventional device shown in Patent Document 1 and Patent Document 2.

Distortion due to self-weight of the large area substrate can be suppressed by keeping the substrate at an inclined position. Conventionally, when keeping the large area substrate in a horizontal state, there has been a problem that the central part of the substrate is bent due to the self-weight, thereby causing increased distortion.

In this invention, since the large area substrate is not revolved, the substrate is not broken without unreasonable force.

In the case of using a doping device of the invention, the substrate is doped from one direction, from a diagonal direction. Namely, only one side of a mask or a material to be the mask is doped. For example, in the case of forming LDD regions of a TFT by doping from a diagonal direction using a gate electrode functioning as a mask, LDD regions which is overlapped with the gate electrode is formed at only one side.

The tilt angle θ of the substrate is an angle between a perpendicular of the large-size substrate and an ion beam. Further, it can also be described that the substrate is transported with setting the angle between the substrate surface and the ion beam to be an angle α (an angle α between the substrate surface and a direction of ion beam irradiation is equal to 90°−θ)

When a substrate is doped diagonally, a tilt angle θ between a surface that is perpendicular to an inclined substrate surface and a direction of ion irradiation is preferably 30° to 60° (or −30° to −60°) in 0°<θ<90°, or −90°<θ<0°. When the substrate is doped in a diagonal direction to the substrate surface, simulation is performed so as to search an optimum angle θ between the ion irradiation direction and the surface perpendicular to the substrate surface. Accordingly, the result of the simulation shown in FIG. 4B and FIG. 5 is obtained. On the assumption of a model view shown in FIG. 4A, a simulation is performed using software referred to as TRIM (Transport of Ion in Matter). TRIM is software to run simulation of ion implantation process by Monte Carlo method. Each numeric value used in the simulation in FIG. 4B is a dose amount of phosphorus: 3×10¹⁵/cm², acceleration voltage: 80 keV, and film thickness in a gate insulating film: 150 nm. Each numeric value used in the simulation in FIG. 5 is a dose amount of boron: 2×10¹⁶/cm², acceleration voltage: 80 keV, and a film thickness in a gate insulating film: 150 nm. In FIG. 4B, and FIG. 5, a longitudinal axis is a wrap-around length L (Lateral length) that is a distance from an end face of the mask, and a horizontal axis is a tilt angle (angle θ shown in FIG. 4A) between a surface perpendicular to the substrate surface and an ion irradiation direction.

A plurality of ion sources may be provided, and various different doping may be sequentially conducted to a transporting substrate. Another structure of the invention is a doping device in which a substrate carry-in chamber, a doping chamber, and a substrate carry-out chamber are serially arranged, in which the doping chamber includes a first means for generating an ion current whose cross section has a linear shape or a rectangle, a second means for generating an ion current whose cross section has a linear shape or a rectangle, and a substrate position control means for moving the substrate to be treated in one direction, and the substrate to be treated which moves from the substrate carry-in chamber to the substrate carry-out chamber in one direction through the doping chamber is irradiated with a plurality of ion currents.

By preparing the plurality of ion sources, a plurality of various different doping may be conducted for a short time.

It is one feature that in each of the above mentioned structure, the means for generating the ion current includes radio-frequency energy, or microwave and a magnetic field. In the case of using the plurality of the ion sources, ion sources each having different structures may be combined.

The invention is not limited to a device structure in which irradiation of an ion beam is conducted in gravitational force direction, and the substrate inclined to near-perpendicular may be irradiated with ion beam in a horizontal direction.

The axis to incline the substrate is not limited to the one which passes through the center of the substrate (an axis that is parallel to a side of the substrate), specifically, and an arbitrary axis or an arbitrary and a plurality of axes may be used. For example, a substrate may be inclined with a diagonal line of the substrate as the axis. In this case, a direction of laser beam irradiation in a TFT manufacturing process may be adjusted to a diagonal line of the substrate. In addition, it is preferable that a TFT is properly arranged in accordance with the diagonal line of the substrate.

It is also one feature that each structure mentioned above, the substrate inclined like the substrate position is moved in the direction perpendicular to the direction of the substrate posture. The direction of the laser beam irradiation may be adjusted to the direction to transport the substrate in the manufacture process of the TFT. Additionally, it is preferable that the TFT is properly arranged in accordance with the direction to transport the substrate.

A laser oscillator used in the invention is not specifically limited, and either of pulse laser oscillator or continuous wave (CW) laser oscillator can be used. As the pulse laser oscillator, an excimer laser, a YAG laser, a YVO₄ laser or the like can be used. As the CW laser oscillator, a YAG laser, a YVO₄ laser, a GdVo₄ laser, a YLF laser, an Ar laser or the like can be used. A CW solid-state laser is used and laser beam with second to fourth harmonics of a fundamental wave is used for irradiation to obtain a crystal with a large grain size which is long-extended along the direction of laser irradiation. Typically, for instance, the second harmonic (532 nm) or the third harmonic (355 nm) of Nd:YVO₄ laser (fundamental wave with 1064 nm) is preferably used. Concretely, a laser beam emitted from the continuous wave YVO₄ laser is converted into a high harmonic by a nonlinear optical element to obtain a laser beam with over several W output. The laser beam is preferably formed to be a rectangular or elliptical shape on a surface to be irradiated and is emitted onto the semiconductor film. In this case, the energy density of about 0.001 to 100 MW/cm² (preferably, 0.1 to 10 MW/cm²) is required. The scanning rate is approximately set to be 0.5 to 2,000 cm/sec (preferably, 10 to 200 cm/sec) for irradiation.

While the oscillation frequency of a pulsed laser beam is set to be 0.5 MHz or more, laser crystallization may be conducted using an extremely higher frequency band than a frequency band of several tens Hz to several hundreds Hz, which is generally used. It is said that the period during which the semiconductor film is irradiated with pulsed laser beam and is solidified completely is several tens nsec to several hundreds nsec. Thus, by using the above mentioned frequency band, irradiation of the next pulsed laser beam can be performed to the semiconductor before the semiconductor film is melted by laser beam irradiation and then solidified. Therefore, a semiconductor film having crystal grains sequentially grown in the scanning direction is formed since a solid-liquid interface can be sequentially moved in the semiconductor film. Specifically, an aggregate of the crystal grains each of which has a width in a scanning direction of 10 to 30 μm and a width in a direction perpendicular to the scanning direction of 1 to 5 μm can be obtained. By forming the single crystal grains growing in the scanning direction, the semiconductor film in which almost no crystal grain boundaries are formed at least in a channel direction of a thin film transistor can be formed.

Further, the substrate is connected to a processing unit which processes the substrate at an inclined position, and thus all of the processing units constituting an in-line system can be also inclined.

### EFFECT OF THE INVENTION

According to the present invention, a manufacturing device of a semiconductor device provided with a device by which a large area substrate can be uniformly doped with an impurity element without revolving can be realized.

### BRIEF DESCRIPTION OF DRAWINGS

FIG. 1A is a perspective view of a doping device of the present invention, and FIG. 1B is a schematic diagram showing a state of a substrate in a doping chamber (Embodiment Mode 1).

FIG. 2 is a top view showing a top view of a doping device of the invention (Embodiment Mode 1).

FIG. 3 is a cross sectional view of a substrate position control mechanism (Embodiment Mode 1).

FIG. 4A is a model diagram used in simulation, and FIG. 4B is a diagram showing the result of simulation (Embodiment Mode 1).

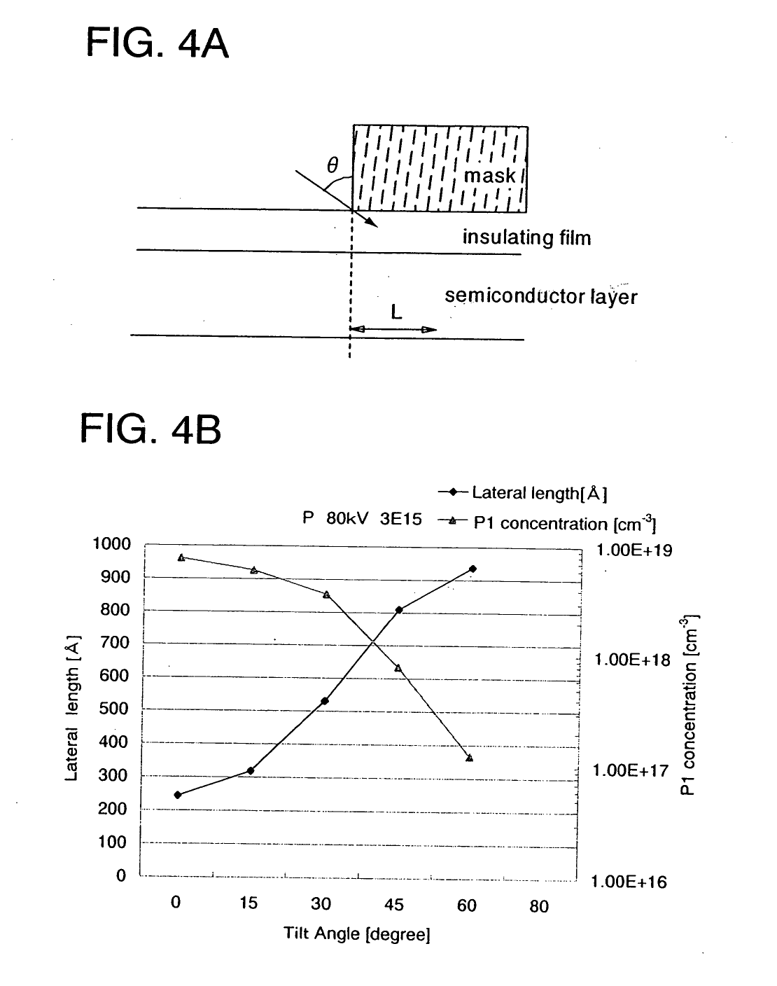

FIG. 5 is diagram showing the result of simulation.

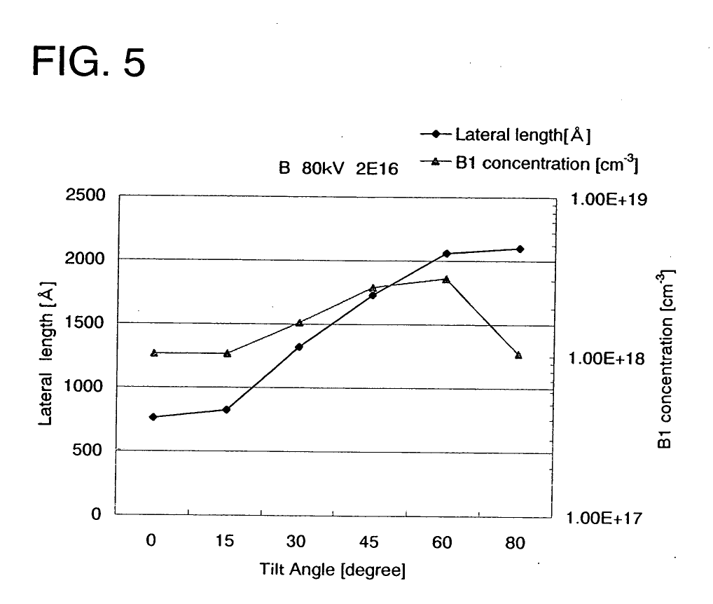

FIG. 6 is a top view of a doping device of the invention (Embodiment Mode 2).

FIG. 7 is an example of a cross sectional view of a substrate position control mechanism (Embodiment Mode 1).

FIGS. 8A to 8D are examples of cross sectional views showing a manufacturing process of a TFT (Embodiment Mode 3).

FIGS. 9A to 9C are a top view and cross sectional views showing a state of a substrate in doping (Embodiment Mode 3).

FIGS. 10A to 10E are examples of cross sectional views showing a manufacturing process of a TFT (Embodiment Mode 3).

FIGS. 11A to 11F are examples of cross sectional views showing variation of a manufacturing process of a TFT (Embodiment Mode 3).

FIGS. 12A and 12B are a model diagram used in simulation and a result thereof.

FIGS. 13A and 13B are a model diagram used in simulation and a result thereof.

FIGS. 14A and 14B are a model diagram used in simulation and a result thereof.

FIGS. 15A and 15B are a model diagram used in simulation and a result thereof.

FIGS. 16A to 16D are diagrams showing a method for manufacturing a semiconductor device (Embodiment Mode 5).

FIGS. 17A to 17C are diagrams showing a method for manufacturing a semiconductor device (Embodiment Mode 5).

FIGS. 18A and 18B are diagrams showing a method for manufacturing a semiconductor device (Embodiment Mode 5).

FIGS. 19A and 19B are diagrams showing a method for manufacturing a semiconductor device (Embodiment Mode 5).

FIGS. 20A and 20B are perspective views showing a semiconductor device (Embodiment Mode 6).

FIG. 21 is a block diagram showing a structure of a semiconductor device (Embodiment Mode 7).

FIG. 22 is a block diagram showing a structure of a semiconductor device (Embodiment Mode 8).

FIGS. 23A to 23C diagrams showing a method for manufacturing a semiconductor device (Embodiment Mode 9).

FIGS. 24A to 24C are diagrams showing a method for manufacturing a semiconductor device (Embodiment Mode 9).

FIGS. 25A to 25C are diagrams showing a method for manufacturing a semiconductor device (Embodiment Mode 9).

FIG. 26 is a diagram showing a method for manufacturing a semiconductor device (Embodiment Mode 9).

FIGS. 27A to 27C are diagrams showing a method for manufacturing a semiconductor device (Embodiment Mode 10).

FIGS. 28A to 28H are application examples in which a semiconductor device is used.

FIGS. 29A and 29B are application examples in which a semiconductor device is used.

FIGS. 30A to 30C are an example of perspective views of a doping device (Embodiment Mode 1).

### DETAILED DESCRIPTION OF THE INVENTION

Best Mode for Carrying Out the Invention

Embodiment modes of the present invention are described below.

### Embodiment Mode 1

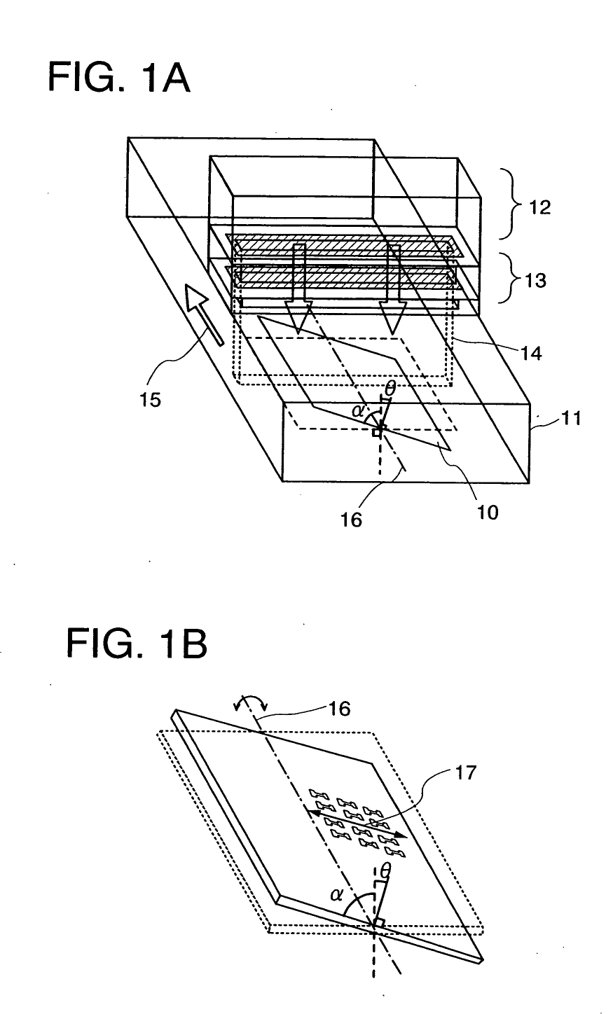

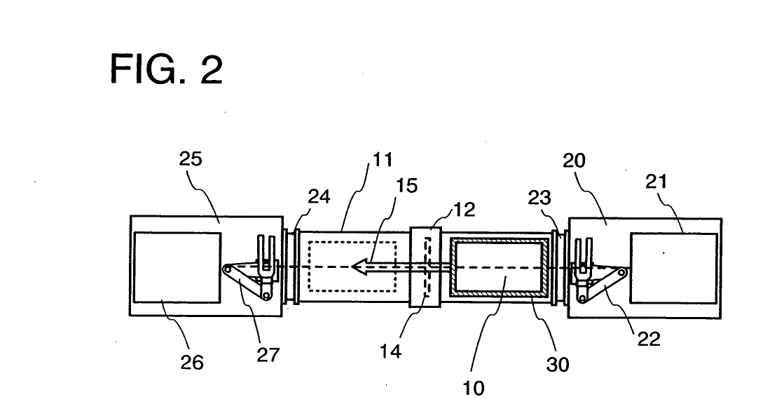

FIG. 1A is a perspective view showing an example of a doping device. FIG. 2 is a top view showing an example of a structure of an entire doping device of the invention. Note that in FIG. 2, the same signal is used in the same part as FIG. 1A.

An ion source 12 includes a thermoelectric emission filaments provided in a chamber, which is a plasma chamber, and a plurality of ring-shaped permanent magnets disposed with alternated polarity around the chamber.

An acceleration electrode portion 13 includes an ion containment electrode in which electric potential is kept as well as that in the chamber which functions as an anode, an extraction electrode whose electric potential is kept lower than that of the ion containment electrode by several kV, and an acceleration electrode whose electric potential is kept lower than the extraction electrode by several ten kV, in an opening portion at the bottom of the chamber. The ion containment electrode, the extraction electrode, and the acceleration electrode are grid electrodes.

The on-state or off-state of the irradiation may be controlled by switching operation with a shutter provided to block an ion beam.

An electron emitted from a filament is made to react with an operation gas (hydrogen, phosphine, diborane, or the like) which is introduced into the chamber from a gas introduction opening to generate plasma. The plasma is shut in the chamber by a magnetic field of the permanent magnetic and an electric field is applied by the extraction electrode, thereby extracting the ion in the plasma through the ion containment electrode. The ion is accelerated by an electric field of the acceleration electrode to generate an ion beam 14.

The irradiation of the ion beam 14 is performed in a doping chamber 11, and the ion is introduced into a substrate 10 at an inclined position. The substrate 10 is inclined using a tilt axis 16 as a center and kept. The cross sectional view of the ion beam 14 is made to be a linear shape or a rectangle and the substrate is moved in a direction perpendicular to a longitudinal direction of the ion beam 14 to conduct a doping process to the entire surface of the substrate.

As shown in FIG. 2, the substrate 10 is moved in a scanning direction 15 to pass through the lower part of the ion source 12. The doping chamber 11 is connected to a substrate carry-in chamber 20 through a gate valve 23. A transfer robot 22 is provided in the substrate carry-in chamber 20, and the substrate 10 is moved to a substrate stage 30 of the doping chamber from a substrate cassette 21 where a plurality of the substrates are stored.

When changing inclination of the substrate to be a horizontal position or an inclined position, the tilt angle of the substrate is changed using the substrate stage 30 or the transfer robot 22.

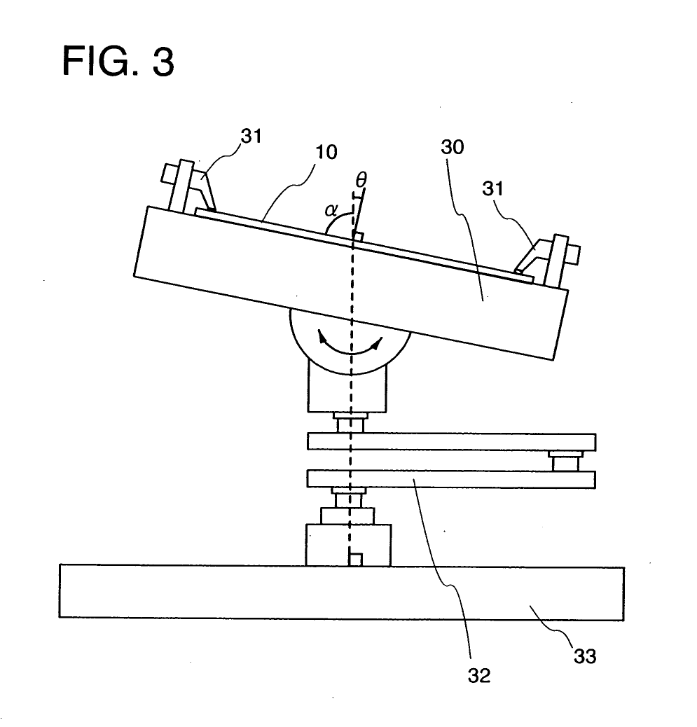

When changing the tilt angle of the substrate by the substrate stage 30, the substrate is moved in the scanning direction and the angle of the substrate stage is adjusted by a substrate position control mechanism 32 as an example shown in FIG. 3. By using the substrate position control mechanism 32 shown in FIG. 3, doping from a horizontal direction is performed, and θ is set at equal to or more than 60° and less than 120°. Thus, it can be used as a substrate perpendicularly standing device. A rail or a driving geared motor may be used to move the substrate in a scanning direction, without limiting to a robot. The angle of the stage is adjusted by angular adjustment means such as a goniometer. A stage provided with the goniometer is also referred to as a goniostage. The goniostage has the center of rotation on the upper side of the stage. And the stage is revolved using it as a supporting point. The surface of the stage is inclined. The angle α is an angle made by a surface including a perpendicular extended from a base 33 and a principal surface of the substrate 10. And the tilt angle θ is an angle made by a surface perpendicular to the substrate surface and the surface including a perpendicular extended from the base 33. Note that the substrate 10 is fixed to the substrate stage 30 using a clamper 31.

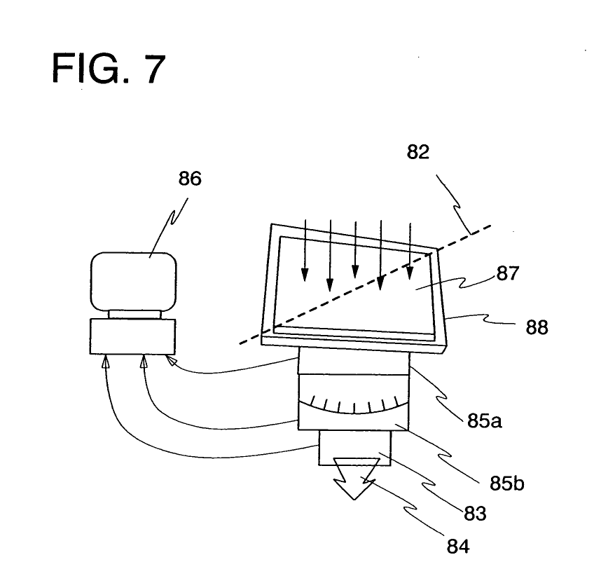

Another example for changing the tilt angle of the substrate is shown in FIG. 7. The substrate is moved in a scanning direction 84 of the substrate by a substrate position control mechanism 83, and a substrate 87 fixed on a stage 88 is scanned. A substrate at a complex inclined position can be kept by using two goniometers 85a and 85b whose axes are orthogonal to each other. For example, the substrate at an inclined position in which a diagonal line of the substrate is to be an axis 82 can be maintained. In this case, the axis 82 and the substrate scanning direction 84 are not orthogonal. By using a first goniometer 85a, an angle made by an X direction and a horizontal plane of the substrate can be changed, and by using a second goniometer 85b, an angle made by a Y direction and a horizontal plane of the substrate can be changed. Thus, an inclination of the semiconductor film on the substrate (angle to the horizontal plane) can be freely arranged. Note that reference numeral 86 shows a PC.

When changing the tilt angle by using the transfer robot 22, a holding portion of the transfer robot 22 can adsorb a substrate, and the holding portion can revolve around a predetermined axis by a drive means. The posture of the holding portion can be changed by rotating the holding portion of the transfer robot 22, and the posture of the substrate that is adsorbed at the holding portion can be changed.

In the substrate cassette 21, the substrate may be stocked at an inclined position. In this case, the substrate can be transferred and doping process can be performed almost without changing the inclined position of the substrate.

Similarly, the doping chamber 11 is connected to a substrate carry-out chamber 25 through a gate valve 24. The substrate carry-out chamber 25 is also provided with a transfer robot 27, and the transfer robot 27 holds the substrate to which the doping process is performed in a substrate cassette 26.

In the doping device of the invention, a substrate having a large area can be treated since the substrate is moved while being kept at an inclined position on by a substrate stage and doping is conducted thereto. Further, since the cross-section of an ion beam is a square and the substrate is irradiated with all of the ion beams, ion irradiation is efficiently performed. Further, the width of the longitudinal direction of the ion beams can be narrowed since the substrate is not revolved.

The present invention is not limited to the above structure of the device, and a structure in which a substrate at an inclined position that is near-perpendicular position is irradiated with ion beams in a horizontal direction may be applied since there is a problem of particles.

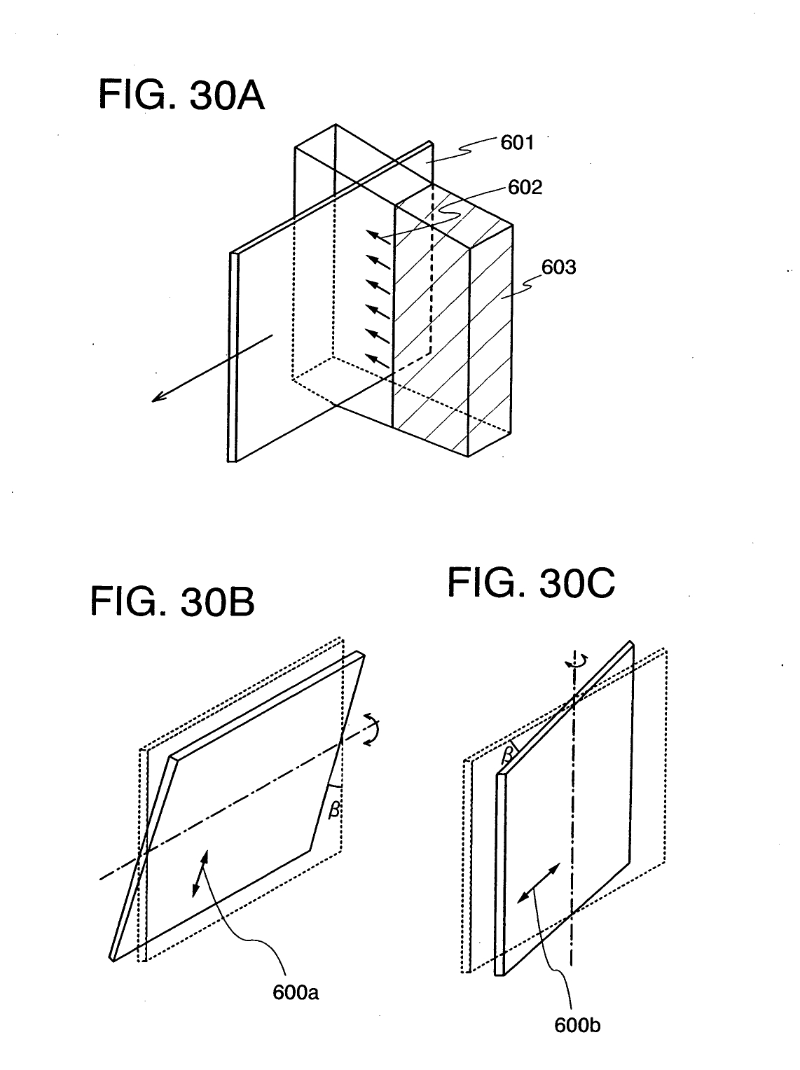

An example of a device structure in which a substrate is placed perpendicularly is shown in FIG. 30A to FIG. 30C. It is preferable to apply the device structure in which a substrate 601 perpendicularly standing is irradiated with an ion beam 602 in a horizontal direction since there is a problem of the particles. Furthermore, it is preferable that the substrate is placed perpendicularly in the substrate cassette and is transferred to the chamber by using a mechanism for transfer the substrate at a standing position. Although a diagram where the ion beams produced from an ion beam irradiation means 603 has a linear shape is shown in FIG. 30A, but the structure is not limited thereto. There are two kinds of ways to move the substrate stage which moves the substrate while holding it (for example, a mechanism shown in FIG. 3). One is a way to incline a substrate by angle β as shown in FIG. 30B, and the other is a way to incline a substrate by angle β as shown in FIG. 30C. When irradiating the substrate with ion beams, the substrate stage may be fixed at an angle β or the angle β may be continuously changed within a certain angle.

In order to perform doping diagonally and forming an impurity region on the lower side of the gate electrode, it is necessary to take the arrangement of the TFT into account. As shown in FIGS. 30B and 30C, it is preferable to design a circuit including TFTs in consideration of the way to move the substrate stage for inclining the substrate and channel length directions 600a and 600b.

The present invention is not limited to the above mentioned device structure, and a substrate transfer roller may be used instead of using the substrate stage to hold and transfer the substrate at an inclined position. In this case, the lower part of the substrate is kept by a holding member such as the transfer roller, and the slanted bottom end is held by a side guide. This side guide serves to control the movement of the substrate toward the lower side of inclined substrate by a lower part holding roller which is in contact with the lower part of the substrate and holding it from its sides.

The doping device of the present invention is not limited to the above mentioned device structure specifically, and an ion convergent device and an ion mass separator which are known in the conventional ion doping technique may be added.

In order to perform doping while holding the substrate diagonally and form an impurity region on the lower side of the gate electrode, it is necessary to take the arrangement of the TFTs into account. FIG. 1B is a schematic diagram briefly showing the state of the substrate in the doping chamber 11. As shown in FIG. 1B, it is preferable to design a circuit including TFTs in consideration of the way to move the substrate stage for inclining a substrate and the channel length direction 17.

### Embodiment Mode 2

In order to perform doping process efficiently, a structure in which a plurality of ion sources is provided in one doping chamber may be applied.

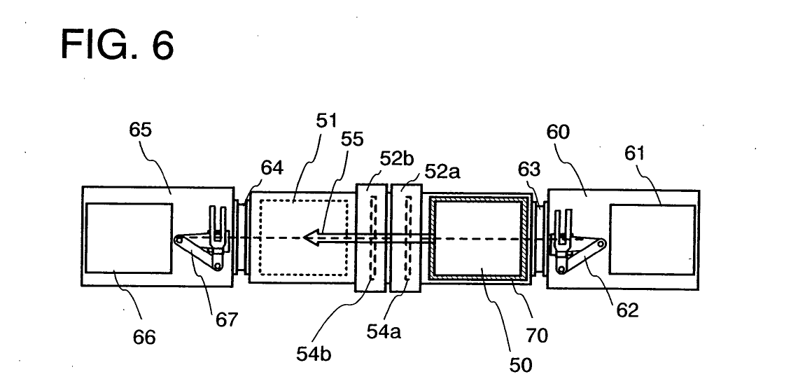

An example of the top view of a whole doping device of the invention is shown in FIG. 6.

A device in which a first ion source 52a and a second ion source 52b are connected in parallel to emit a first ion beam 54a and a second ion beam 54b respectively, as shown in FIG. 6, is provided.

A substrate 50 is carried from a substrate cassette 61 in a substrate carry-in chamber 60 to a doping chamber 51 using a transfer robot 62 through a gate valve 63. The substrate 50 is placed on a substrate stage 70 and the ion doping is performed twice when the substrate is moved in a scanning direction 55 in the doping chamber 51 and passes below the two ion sources. The substrate to which doping has been done is stored in a substrate cassette 66 of a substrate carry-out chamber 65 by a transfer robot 67 through a gate valve 64.

For instance, on the condition that two ion sources have a different accelerating voltage each other, a first doping process for forming a high concentration impurity region and a second doping process for forming a low concentration impurity region can be sequentially performed.

The number of the ion sources is not limited to two, three, or more ion sources may be provided.

Further, this embodiment mode can be freely combined with Embodiment Mode 1. In this embodiment mode, an example of moving the substrate while being kept horizontally is shown; however, a stage having an angle adjustment function may be used as in Embodiment Mode 1, to move the substrate at an inclined position.

### Embodiment Mode 3

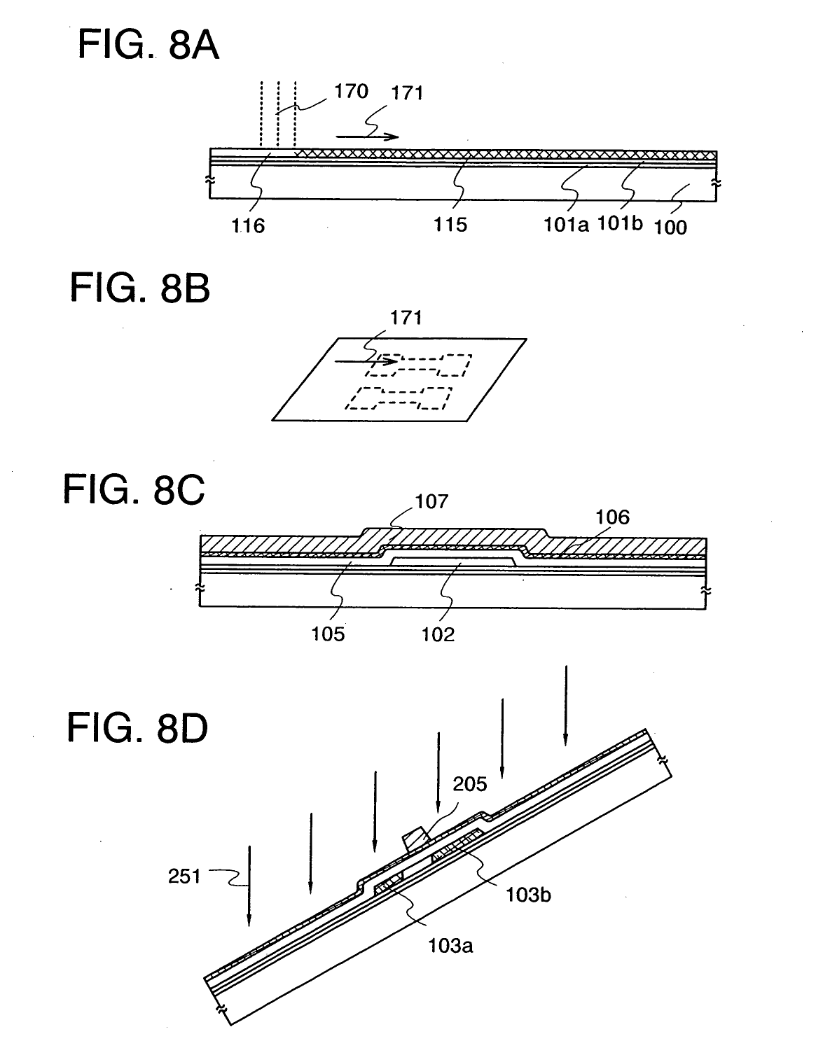

A method for manufacturing a thin film transistor using a doping device shown in this embodiment mode is described with reference to FIG. 8 to FIG. 11.

A base film 101a is formed to have a film thickness of 10 to 200 nm (preferably, from 50 to 100 nm) using a silicon nitride oxide (SiNO) film by sputtering, PVD, low-pressure CVD (LPCVD), CVD (Chemical Vapor Deposition) such as plasma CVD, or the like, and a base film 101b is stacked thereon to have a film thickness of 50 to 200 nm (preferably, from 100 to 150 nm) using a silicon oxynitride (SiON) film, over a substrate 100 having an insulating surface as a base film. In this embodiment mode, plasma CVD is used to form the base film 101a and the base film 101b. As the substrate 100, a glass substrate, a quartz substrate, a silicon substrate, a metal substrate, or a stainless substrate over which an insulating film is formed may be used. Additionally, a plastic substrate having heat-resistance which can withstand a process temperature of this embodiment mode, or a flexible substrate like a film may also be used. In addition, a two-layer structure may be used for the base film, or a single-layer film structure of the base (insulating) film or a structure in which two or more base (insulating) films are stacked to have two layers or more may be also used.

Subsequently, a semiconductor film is formed over the base film. The semiconductor film may be formed to have a thickness of 25 to 200 nm (preferably, from 30 to 150 nm) by a known method such as sputtering, LPCVD, or plasma CVD. In this embodiment mode, a crystalline semiconductor film made by laser-crystallizing an amorphous semiconductor film is preferably used.

An amorphous semiconductor (hereinafter, also referred to as an “AS”) manufactured using a semiconductor material gas typified by silane or germane by vapor phase growth or a sputtering; a polycrystalline semiconductor that is formed by crystallizing the amorphous semiconductor using light energy or thermal energy; a semi-amorphous semiconductor (also referred to as microcrystalline or microcrystal, and hereinafter, also referred to as an “SAS”); or the like can be used for a material which forms a semiconductor film.

The SAS is a semiconductor having an intermediate structure between an amorphous structure and a crystalline structure (including a single crystal and a poly-crystal) and having a third state which is stable in terms of free energy, and includes a crystalline region having short-range order and lattice distortion. A crystalline region of from 0.5 to 20 nm can be observed at least in a part of a region in the film. When silicon is contained as the main component, a Raman spectrum is shifted to a lower wave number side than 520 cm⁻¹. Diffraction peaks of (111) and (220) to be caused by a crystal lattice of silicon are observed in X-ray diffraction. Hydrogen or halogen of at least 1 atomic % or more is contained to terminate dangling bonds. The SAS is formed by glow discharge decomposition (plasma CVD) of a silicide gas. Si₂H₆, SiH₂Cl₂, SiHCl₃, SiCl₄, SiF₄, or the like can be used as the silicide gas in addition to SiH₄. Further, F₂ or GeF₄ may be mixed. This silicide gas may be diluted with H₂, or H₂ and one or more rare gas elements selected from He, Ar, Kr, and Ne. The dilution ratio ranges from 2 to 1,000 times. The pressure ranges approximately from 0.1 Pa to 133 Pa, and the power frequency ranges from 1 MHz to 120 MHz, preferably from 13 MHz to 60 MHz. The substrate heating temperature is preferably 300° C. or less, and the film can also be formed at a substrate heating temperature of 100° C. to 200° C. It is desirable that an impurity element of an atmospheric component such as oxygen, nitrogen, or carbon is 1×10²⁰ cm⁻³ or less as an impurity element taken when the film is formed; specifically, an oxygen concentration is 5×10¹⁹ cm⁻³ or less, preferably 1×10¹⁹ cm⁻³ or less. A preferable SAS can be obtained by further promoting lattice distortion by adding a rare gas element such as helium, argon, krypton or neon to enhance stability. Additionally, a SAS layer formed using a hydrogen-based gas may be stacked, as a semiconductor film over a SAS layer formed using a fluorine-based gas.

An amorphous semiconductor is typified by hydrogenated amorphous silicon, and a crystalline semiconductor is typified by polysilicon. Polysilicon (polycrystalline silicon) includes a so-called high temperature polysilicon using polysilicon which is formed at a process temperature of 800° C. or more as a main material, a so-called low temperature polysilicon using polysilicon which is formed at a process temperatures of 600° C. or less as a main material, polysilicon crystallized by adding an element thereto or the like which promotes crystallization, or the like. As described above, a semiamorphous semiconductor or a semiconductor which contains a crystal phase in a part of the semiconductor layer can also be used.

When a crystalline semiconductor layer is used as the semiconductor film, a known method (laser crystallization, thermal crystallization, thermal crystallization using an element promoting crystallization such as nickel, or the like) may be employed as a method for manufacturing the crystalline semiconductor layer. A microcrystalline semiconductor which is a SAS can be crystallized by being irradiated with laser light to enhance the crystallinity. In the case where an element promoting crystallization is not used, the hydrogen is released until hydrogen concentration contained in an amorphous semiconductor film becomes 1×10²⁰ atoms/cm³ or less by heating it for one hour at a temperature of 500° C. in a nitrogen atmosphere before irradiating the amorphous semiconductor film with laser light. This is because an amorphous semiconductor film is damaged when the amorphous semiconductor film containing much hydrogen is irradiated with laser light.

Any method can be used for introducing a metal element into the amorphous semiconductor film without limitation as long as the method is capable of making the metal element exist on the surface or inside the amorphous semiconductor film. For example, sputtering, CVD, a plasma treatment (including plasma CVD), an adsorption method, or a method for applying a metal salt solution can be employed. Among them, the method using a solution is simple and easy and is advantageous in terms of adjusting concentration of the metal element easily. It is preferable to form an oxide film by UV light irradiation in an oxygen atmosphere, thermal oxidation, treatment with ozone water including a hydroxylradical or hydrogen peroxide, or the like in order to improve wettability of the surface of the amorphous semiconductor layer and to spread the aqueous solution over the entire surface of the amorphous semiconductor film.

A crystal having a large grain size can be obtained by irradiation of laser light with any one of second to fourth harmonics of the fundamental wave using a continuous wave solid-state laser. For example, typically, it is preferable to use the second harmonic (532 nm) or the third harmonic (355 nm) of an Nd:YVO₄ laser (fundamental wave 1064 nm). Specifically, the laser light emitted from the continuous wave YVO₄ laser is converted into the harmonic by a non-linear optical element to obtain laser light having several W output or more. It is preferable to shape the laser light into rectangular or elliptical on an irradiated surface through an optical system to irradiate a semiconductor film. The laser light needs to have the energy density of approximately 0.001 to 100 MW/cm² (preferably, from 0.1 to 10 MW/cm²). The scanning speed is set in the range of approximately 0.5 to 2000 cm/sec (preferably, 10 to 200 cm/sec) for the irradiation.

The laser can be a known continuous wave gas laser or solid-state laser. As the gas laser, there are an Ar laser, a Kr laser, and the like. As the solid-state laser, there are a YAG laser, a YVO₄ laser, a YLF laser, a YAlO₃ laser, a Y₂O₃ laser, a glass laser, a ruby laser, an alexandrite laser, or a Ti:Sapphire laser, and the like.

Moreover, a pulsed laser may be employed to conduct laser crystallization. In this case, the oscillation frequency rate is set to 0.5 MHz or more. This frequency band is extremely higher than the frequency band of several ten Hz to several hundred Hz, which is generally used. It is said that it takes several ten to several hundred nanoseconds to completely solidify the semiconductor film after the semiconductor film is irradiated with the pulsed laser light. By using the above described frequency band, it is possible to irradiate with next pulsed laser light before the semiconductor film that has been melted by laser light is solidified. Therefore, the interface between the solid phase and the liquid phase can be continuously moved in the semiconductor film, and the semiconductor film having a crystal grain continuously grown in the scanning direction is formed. Specifically, it is possible to form an aggregation of crystal grains each of which has a width of 10 to 30 μm in the scanning direction and a width of approximately 1 to 5 μm in a direction perpendicular to the scanning direction. It is also possible to form a semiconductor film having almost no crystal grain boundaries at least in the channel direction of the thin film transistor by forming a crystal grain long extended along the scanning direction.

The irradiation with the laser light may be conducted in an inert gas atmosphere such as a rare gas or nitrogen. This enables the roughness of a semiconductor surface to be controlled by the irradiation with the laser light and variations in threshold value generated by variations in interface state density to be controlled.

The amorphous semiconductor film may be crystallized by combining thermal treatment and laser light irradiation, or thermal treatment or laser light irradiation may be separately performed plural times.

In this embodiment mode, an amorphous semiconductor film 115 is formed on the base film 101b using amorphous silicon. The amorphous semiconductor film 115 is irradiated with laser light 170 scanned in a direction of an arrow 171 to be crystallized, thereby forming a crystalline semiconductor film 116 (refer to FIGS. 8A and 8B). Note that FIG. 8B shows a typical perspective view in irradiation. Laser irradiation is scanned so that a part surrounded with dotted lines conforms with a channel length direction.

Such obtained semiconductor film may be doped with a minute amount of impurity element (boron or phosphorous) in order to control a threshold value of a thin film transistor; however, in this embodiment mode, the threshold value of the thin film transistor is controlled by manufacturing an n-channel thin film transistor having a low concentration p-channel impurity region. Thus, according to the invention, it is not necessarily to perform a doping process for controlling the threshold value; therefore, the steps are simplified.

The crystalline semiconductor film 116 is patterned using a mask. In this embodiment mode, a photo mask is formed and a patterning process is conducted by photolithography to form a semiconductor layer 102

Either plasma etching (dry etching) or wet etching may be adopted for the etching in patterning. However, plasma etching is suitable to treat a large substrate. A fluorine-based gas such as CF₄ or NF₃ or chlorine-based gas such as Cl₂ or BCl₃ is used as the etching gas, and an inert gas such as He or Ar may be appropriately added. In addition, a local discharge process can be performed when an atmospheric pressure discharge etching process is applied, and a mask layer need not be entirely formed over the substrate.

In this embodiment mode, a conductive layer for forming a wiring layer or an electrode layer, a mask layer for forming a predetermined pattern, or the like may be formed by a method with which a pattern can be selectively formed, such as droplet discharge. In the droplet discharge (also referred to as ink-jetting according to the system thereof), a predetermined pattern (a conductive layer, an insulating layer, and the like) can be formed by selectively discharging (ejecting) liquid of a composition prepared for a specific purpose. In this case, pre-processing to form a titanium oxide film or the like may be performed in a region to be formed thereon. Additionally, a method for transferring or describing a pattern, for example, printing (a method for forming a pattern of a screen print, an offset print, or the like) or the like can be used.

In this embodiment mode, a resin material such as an epoxy resin, an acrylic resin, a phenol resin, a novolac resin, a melamine resin, or an urethane resin is used as a mask. Alternatively, the mask may also be made of an organic material such as benzocyclobutene, parylene, flare and polyimide having a light transmitting property; a compound material formed by polymerization of a siloxane polymer or the like; a composition material containing a water-soluble homopolymer and a water-soluble copolymer; and the like. In addition, a commercially available resist material containing a photosensitive agent may be also used. For example, it is possible to use a typical positive resist including a novolac resin and a naphthoquinonediazide compound that is a photosensitive agent; a base resin that is a negative resist, diphenylsilanediol, an acid generating material, and the like. The surface tension and the viscosity of any material are appropriately adjusted by controlling the solvent concentration, adding a surfactant, or the like, when droplet discharge is used.

A gate insulating layer 105 covering a semiconductor layer 102 is formed. The gate insulating layer 105 comprises an insulating film containing silicon to have a thickness of from 40 to 150 nm by plasma CVD or sputtering. The gate insulating layer 105 may be formed of a known material such as an oxide material or nitride material of silicon, and may be a laminated layer or a single layer. In this embodiment mode, a laminated structure is used for the gate insulating layer. A thin silicon oxide film is formed over the semiconductor layer 102 at a film thickness of 1 to 100 nm, preferably 1 nm to 10 nm, and further preferably 2 to 5 nm, as a first insulating film. The semiconductor surface is oxidized by a GRTA (Gas Rapid Thermal Anneal), a LRTA (Lamp Rapid Thermal Anneal), or the like and a thermal oxide film is formed, thereby forming the first insulating film to be a thin film. In this embodiment mode, a laminated layer of three-layer: a silicon nitride film, a silicon oxide film, and a silicon nitride film is used over the first insulating film. Alternatively, a single layer of a silicon oxynitride film or a laminated layer of two layers thereof may be also used. Preferably, a precise silicon nitride film may be used. Note that a rare gas element such as argon may be added to a reactive gas and be mixed into an insulating film to be formed in order to form a precise insulating film having little gate leak current at a low film formation temperature.

A first conductive film 106 having a film thickness of 20 to 100 nm and a second conductive film 107 having a film thickness of 100 to 400 nm, each of which serves as a gate electrode are laminated over the gate insulating layer 105 (FIG. 8C). The first conductive film 106 and the second conductive film 107 can be formed by a known method such as sputtering, vapor deposition, or CVD. The first conductive film and the second conductive film may be formed of an element selected from tantalum (Ta), tungsten (W), titanium (Ti), molybdenum (Mo), aluminum (Al), copper (Cu), chromium (Cr), and neodymium (Nd), or an alloy material or compound material having the foregoing element as a main component. A semiconductor film typified by a polycrystalline silicon film that is doped with an impurity element such as phosphorus or an AgPdCu alloy may be used as the first conductive film and the second conductive film. The conductive film is not limited to the two-layer structure, and, for example, may have a three-layer structure in which a 50 nm thick tungsten film, a 500 nm thick alloy film of aluminum and silicon (Al—Si), and a 30 nm thick titanium nitride film are sequentially laminated. In the case of the three-layer structure, tungsten nitride may be used in stead of tungsten of the first conductive film; an alloy film of aluminum and titanium (Al—Ti) may be used in stead of an alloy film of aluminum and silicon (Al—Si) of the second conductive film; or a titanium film may be used in stead of a titanium nitride film of a third conductive film. Further, a single layer structure may be also used. In this embodiment mode, tantalum nitride (TaN) is used for the first conductive film 106 and tungsten (W) is used for the second conductive film 107.

Then, a mask comprising a resist is formed by photolithography and the first conductive film 107 is patterned to form a first gate electrode layer 205. The first conductive film can be etched to have a desired tapered shape by appropriately adjusting an etching condition (electric power applied to a coil-shaped electrode layer, electric power applied to an electrode layer on a substrate side, electrode temperature on a substrate side, or the like) by ICP (Inductively Coupled Plasma) etching. As an etching gas, a chlorine-based gas typified by Cl₂, BCl₃, SiCl₄, CCl₄, or the like, a fluorine-based gas typified by CF₄, SF₆, NF₃, or the like, or O₂ can be appropriately used.

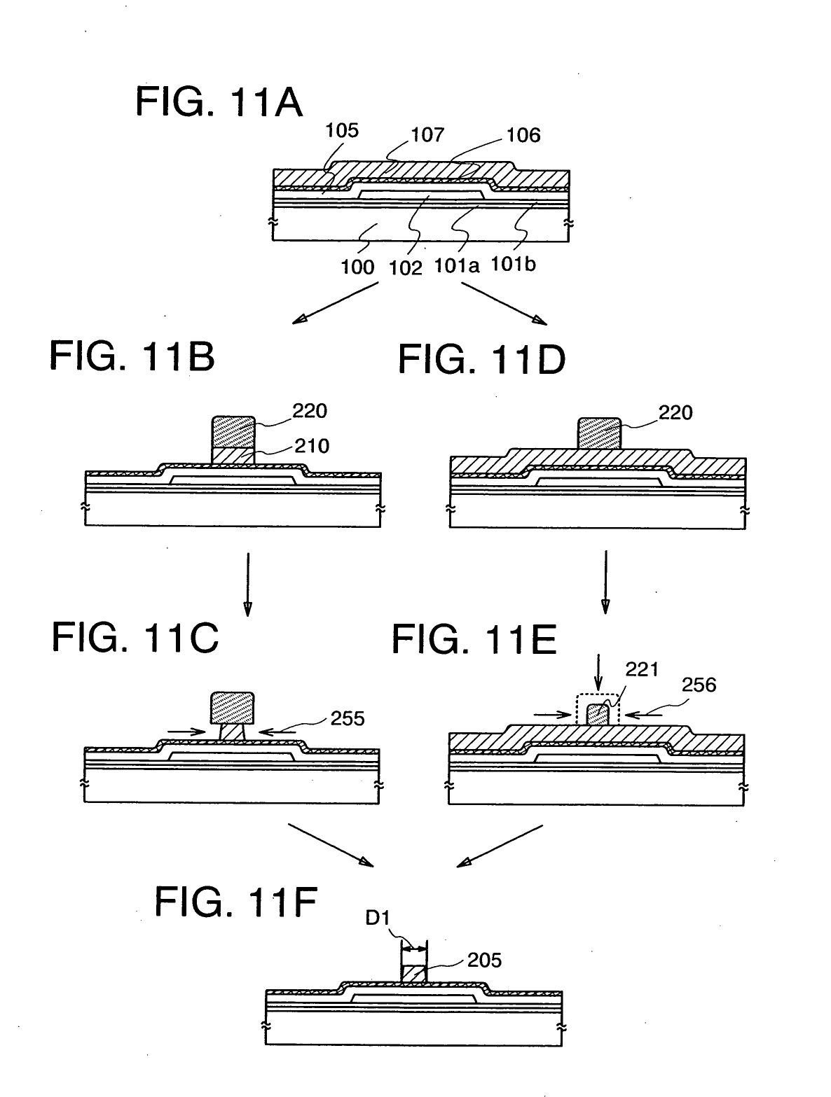

A thin film transistor capable of high speed operation can be formed by narrowing the width D1 of the gate electrode layer. Two methods for forming the first gate electrode layer 205 to narrow the width in a channel direction are shown in FIGS. 11A to 11F. FIG. 11A corresponds to FIG. 8C and shows up to a step for forming the first conductive film 107 over the substrate 100.

First, a first method is described with reference to FIGS. 11B, 11C, and 11F. A mask 220 comprising a resist is formed over the first conductive film 107 by photolithography or droplet discharge. As shown in FIG. 11B, the first conductive film 107 is etched using the mask 220 to form a first gate electrode layer 210. Then, the first gate electrode layer 210 is etched in the direction of an arrow 255 without removing the mask 220. The first gate electrode layer 210 is narrowed to have the width of the first gate electrode layer 205 so as to form the first gate electrode layer 205 (FIG. 11C). After the mask 220 is removed, the first gate electrode layer 205 can be completed to have the width D1 of the gate electrode of 200 nm to 1500 nm, preferably 200 nm to 700 nm.

A second method is described with reference to FIGS. 11D, 11E, and 11F. A mask 220 comprising a resist is formed over the second conductive film 107 by photolithography or droplet discharge. The mask 220 is made further slim by etching, ashing, or the like in a direction of an arrow 256 to form a mask 221 having a narrower width (FIG. 11E). The second conductive film 107 is patterned using the mask 221 formed to have an elongated shape and the mask 221 is removed. Thereby, the first gate electrode layer 205 in which the width D1 of the gate electrode layer is similarly narrow can be formed. Setting the width D1 of the gate electrode layer within the aforesaid limits enables a thin film transistor which has a short channel length to be subsequently formed and a semiconductor device capable of high speed operation to be formed.

Then, the semiconductor layer is doped with an impurity element 251 imparting p-type, using the first gate electrode layer 205 as a mask. Here, the semiconductor layer 102 is doped with an impurity element imparting p-type at the incident angle of less than 60 degrees, preferably 5 degrees to 45 degrees, to the surface thereof, thereby forming a first p-type impurity region 103a and a first p-type impurity region 103b (FIG. 8D). The semiconductor layer is doped with the impurity element imparting p-type obliquely to the surface thereof. Therefore, a region covered with the first gate electrode layer 205 in the semiconductor layer 102 is also doped, thereby forming a first p-type impurity region 103b. However, some impurity elements imparting p-type are blocked by the first gate electrode layer 205; therefore, the first p-type impurity region 103a is not formed in the region covered with the first gate electrode layer 205 in the semiconductor layer. The doping is conducted so that the first p-type impurity region 103a and the first p-type impurity region 103b include the impurity elements imparting p-type to be a concentration of approximately 5×10¹⁷ to 5×10¹⁸/cm³. In addition, the concentration thereof may be set at approximately 5×10¹⁶ to 5×10¹⁷/cm³. In this embodiment mode, boron (B) is used as the impurity elements imparting p-type.

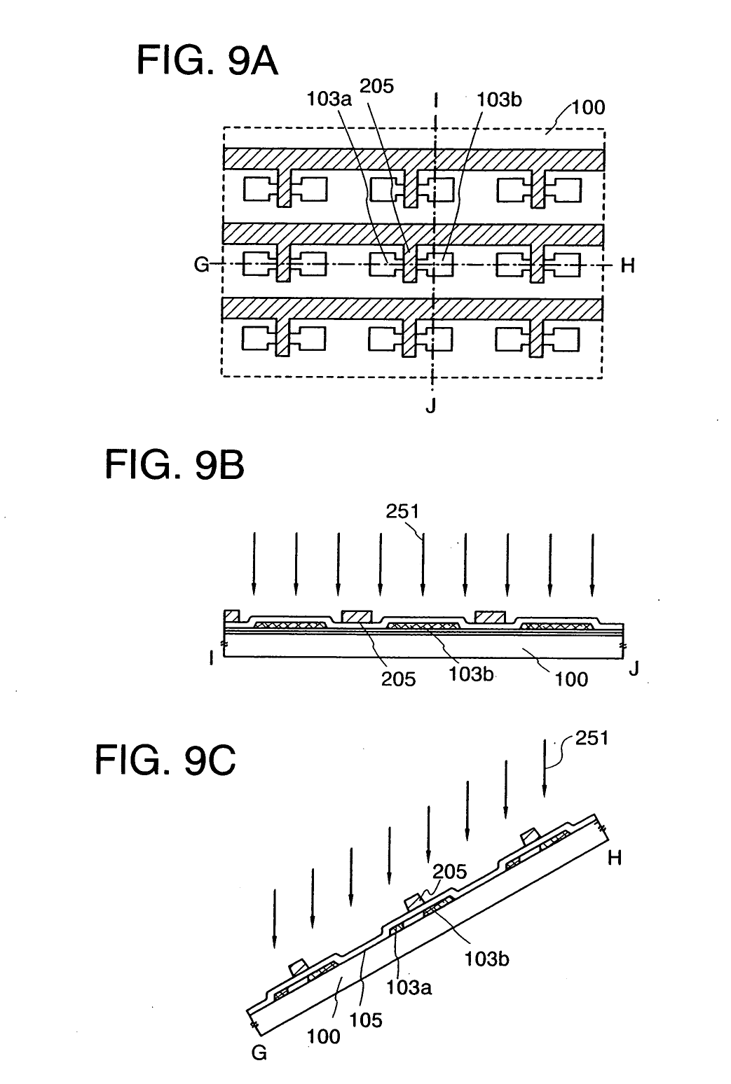

The state of the substrate in doping is shown in FIG. 9A to FIG. 9C. FIG. 9A is a top view, FIG. 9B is a cross section when cutting the substrate by a dotted line IJ in FIG. 9A, and FIG. 9C is a cross section when cutting the substrate by a dotted line GH in FIG. 9A. Further, FIG. 9C is the same as FIG. 8D. Note that, in FIG. 9A to 9C, the same symbol is used in the same part as FIG. 8A to 8D.

When the substrate is cut at parallel surface to an axis around which the substrate revolves, it seems that the substrate is doped with an impurity element perpendicularly, as shown in FIG. 9B, it is not specifically limited thereto. When the substrate is inclined with a plurality of axes using a stage shown in FIG. 7, the substrate can be doped diagonally even when the substrate is cut at any aspects.

In this embodiment mode, a region where the impurity region is overlapped with the gate electrode layer with the gate insulating layer interposed therebetween is referred to as an Lov region and a region where the impurity region is not overlapped with the gate electrode layer with the gate insulating layer interposed therebetween is referred to as an Loff region. The region which is overlapped with the gate electrode 205 in the impurity regions 103a and 103b is shown by a hatch and a blank; however, this does not mean that the blank portion is not doped with boron. This viscerally shows that the concentration distribution of boron in this region reflects the film thickness in the taper portion of the gate electrode layer 205. Note that this is the same as in other diagrams of this description.

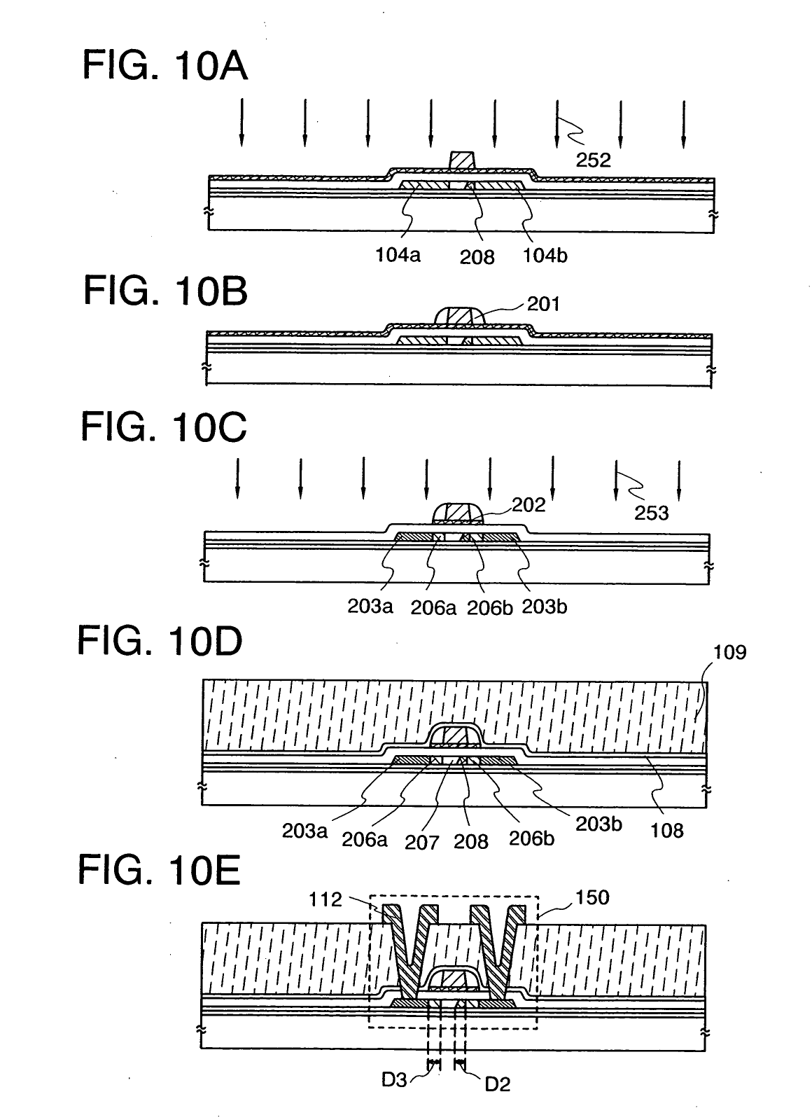

The semiconductor layer is doped with an impurity element 252 imparting n-type, using the first gate electrode layer 205 again as a mask. The semiconductor layer 102 is doped with the impurity element 252 imparting n-type perpendicular to the surface, thereby forming a first n-type impurity region 104a and a first n-type impurity region 104b (FIG. 10A). The first n-type impurity region 104a and the first n-type impurity region 104b have been doped with the impurity element imparting p-type; therefore, they are required to be doped with an impurity element imparting n-type which has a higher concentration than the impurity element imparting p-type of the first p-type impurity region 103a and the first p-type impurity region 103b in order to change p-type to n-type. The first n-type impurity region 104a and the first n-type impurity region 104b include the impurity elements imparting n-type at a concentration of 1×10¹⁷ to 5×10¹⁸/cm³ typically. In this embodiment mode, phosphorous (P) is used as the impurity elements imparting n-type.

Here, the semiconductor layer 102 is doped with the impurity element 252 imparting n-type in a self-alignment manner, using the first gate electrode layer 205. A region which is overlapped with the first gate electrode layer 205 in the first p-type impurity region 103b remains the p-type impurity region, without being doped with the impurity element 252 imparting n-type. Therefore, a second p-type impurity region 208 is formed in the semiconductor layer 102 and the second p-type impurity region 208 is an Lov region. On the contrary, the first n-type impurity region 104a and the first n-type impurity region 104b are Loff regions since they are not covered with the gate electrode layer 205.

Next, after forming an insulating layer covering the first conductive film 106, the gate electrode layer 205, and the like, this insulating layer is processed by anisotropic etching of an RIE (reactive ion etching) to form a sidewall (side wall spacer) 201 on a side wall of the gate electrode layer 205 in a self-alignment manner (FIG. 10B). Here, the insulating layer is not particularly limited. However, it is preferable that the insulating layer includes silicon oxide formed to have preferable step coverage by reacting TEOS (Tetra-Ethyl-Orso-Silicate), silane, or the like with oxygen, nitrous oxide, or the like. The insulating layer can be formed by thermal CVD, plasma CVD, atmospheric pressure CVD, bias ECR CVD, sputtering, or the like.

In this embodiment mode, the first conductive film 106 functions as an etching stopper so that the gate electrode layer is formed to have a lamination structure. Next, the first conductive film 106 is etched using the first gate electrode layer 205 and the side wall 201 as a mask to form a second gate electrode layer 202. In this embodiment mode, a material which has a high etching selectivity between the first conductive film 106 and the second conductive film 107 is used; therefore, the first gate electrode layer 205 can be used as a mask when the first conductive film 106 is etched. In the case of using a material which does not have a high etching selectivity between the first conductive film 106 and the second conductive film 107, it is preferable that the insulating layer is left when the sidewall 201 is formed, a mask comprising a resist is formed over the first gate electrode layer 205, or the like. Protecting the first gate electrode layer 205 can prevent the first gate electrode layer 205 from being reduced when the first conductive film 106 is etched. Etching may include a known etching method such as dry-etching and wet-etching. In this embodiment mode, a dry etching is used. Note that a chlorine-based gas typified Cl₂, BCl₃, SiCl₄, and CCl₄; a fluorine-based gas typified by CF₄, SF₆, and NF₃; or O₂ can be appropriately used for the etching gas.

The semiconductor layer 102 is doped with an impurity element 253 imparting n-type perpendicular to the surface thereof, using the sidewall 201 and the first gate electrode layer 205 as a mask, thereby forming a second n-type impurity region 203a and a second n-type impurity region 203b (FIG. 10C). Here, the second n-type impurity region 203a and the second n-type impurity region 203b are formed to include the impurity elements imparting n-type in a concentration of approximately 5×10¹⁹ to 5×10²⁰/cm³. In this embodiment mode, phosphorous (P) is used as the impurity elements imparting n-type. Regions which are not doped with the impurity elements imparting n-type due to the sidewall 201 as a mask become a third n-type impurity region 206a and a third n-type impurity region 206b. The third n-type impurity region 206a and the third n-type impurity region 206b are Lov regions, since they are covered with a second gate electrode 202. Note that a channel formation region 207 is formed into the semiconductor layer 102 (FIG. 10C).

The second n-type impurity region 203a and the second n-type impurity region 203b are high concentration impurity regions each of which has a high concentration of the impurity elements imparting n-type, and they function as a source region or a drain region. On the other hand, the third n-type impurity region 206a and the third n-type impurity region 206b are low concentration impurity regions. Then, an electrical field adjacent to a drain can be relieved and deterioration of on-state current due to hot carriers can be controlled, since the third n-type impurity region 206a and the third n-type impurity region 206b are covered with the second gate electrode layer 202. Hereby, a semiconductor device capable of high speed operation can be formed.

Heat treatment, irradiation of intense light, or irradiation of laser light may be carried out in order to activate the impurity elements. Plasma damage to the gate insulating film or plasma damage to the interface between the gate insulating film and the semiconductor layer can be recovered simultaneously with the activation.

Next, an insulating film 108 containing hydrogen is formed as a passivation film. The insulating film 108 is formed with an insulating film containing silicon to a thickness from 100 nm to 200 nm by plasma CVD or sputtering. The insulating film 108 is not limited to a silicon nitride film, and a silicon nitride oxide (SiNO) film by plasma CVD, or a single layer or a stack of other insulating films containing silicon may be used.

Moreover, the step for hydrogenating the semiconductor layer is performed by heat treatment at a temperature of 300° C. to 550° C. for 1 hour to 12 hours under a nitrogen atmosphere. The step is preferably performed at a temperature of 400° C. to 500° C. This step is a step for terminating dangling bonds of the semiconductor layer due to hydrogen contained in the insulating film 108.

The insulating film 108 comprises a material selected from silicon nitride, silicon oxide, silicon oxynitride (SiON), silicon nitride oxide (SiNO), aluminum nitride (AlN), aluminum oxynitride (AlON), aluminum nitride oxide (AlNO) having more nitrogen content than oxygen content, aluminum oxide, diamond like carbon (DLC), and a nitrogen-containing carbon film (CN) film. Alternatively, a material in which a skeletal structure is constructed by the combination of silicon (Si) and oxygen (O), and a substituent contains at least hydrogen, or at least one of fluorine, an alkyl group, and aromatic hydrocarbon may be used.

Then, an insulating layer 109 to be an interlayer insulating film is formed (FIG. 10D). According to the invention, an interlayer insulating film for planarization is required to be highly heat resistant and electrically insulative, and having high planarization coefficient. Such an interlayer insulating film is preferably formed by coating typified by spin coating.

In this embodiment mode, an application film using a material in which a skeletal structure is constructed by the combination of silicon (Si) and oxygen (O), and a substituent contains at least one kind of hydrogen, fluorine, an alkyl group, or aromatic hydrocarbons may be used. The film after being baked can be referred to as a silicon oxide (SiOx) film containing an alkyl group. This silicon oxide (SiOx) film containing alkyl group can withstand heat treatment of 300° C. or more.

Dipping, spraying application, a doctor knife, a roll coating, a curtain coating, a knife coating, CVD, vapor deposition can be used for the insulating layer 109. In addition, the insulating layer 109 may be formed by droplet discharge. A material solution can be saved when droplet discharge is applied. A method capable of lithography or delineation of a pattern like droplet discharge, for example, printing (a method in which a pattern is formed such as screen printing or offset printing), or the like can also be used. Spin coating may be used for the insulating layer 109. An inorganic material may be used, and in this case, silicon oxide, silicon nitride, and silicon oxynitride may be used.

In addition to an insulating film in which a skeletal structure is constituted by bonding silicon (Si) and oxygen (O), the insulating layer 109 can also be formed using a film formed of a kind or a plural kinds of an inorganic material (silicon oxide, silicon nitride, silicon oxynitride, silicon nitride oxide, PSG (phosphorous glass), a BPSG (boron phosphorous glass), an alumina film, or the like); a photosensitive or non-photosensitive organic material (organic resin material), such as polyimide, acryl, polyamide, polyimide amide, benzocyclobutene, or the like; a resist; or a Low k material having low dielectric constant, or using a lamination of these materials.

A contact hole (opening portion) reaching the semiconductor layer 102 is formed using a mask comprising a resist in the insulating layer 109, the insulating film 108, and the gate insulating layer 105. Etching may be conducted once or multiple times according to the selectivity of used materials. A first etching is conducted on a condition which is the high selectivity between the insulating layer 109, the insulating layer 108 and the gate insulating layer 105, thereby removing portions of the insulating layer 109 and the insulating layer 108. A second etching removes portions of the gate insulating layer 105, thereby forming opening portions reaching the second n-type impurity region 203a and the second n-type impurity region 203b which are a source region or a drain region.

The first etching is conducted so as to remove the portions of the insulating layer 109 and the insulating film 108. Wet etching or dry etching is performed as the etching. An inert gas may be added into a used etching gas. An element or plural elements of He, Ne, Ar, Kr, and Xe can be used for the inert element to be added. Specifically, it is preferable to use argon having a comparatively large atomic radius and which is inexpensive. In this embodiment mode, CF₄, O₂, He, and Ar are used. An etching condition during dry etching is set in a flow rate of CF₄ to be 380 sccm; a flow rate of O₂, 290 sccm; a flow rate of He, 500 sccm; a flow rate of Ar, 500 sccm; a RF power, 3000 W; and a pressure, 25 Pa. According to the above condition, an etching residue can be decreased.

In order to conduct etching without leaving a residue on the gate insulating layer 105, etching time is increased at the rate of approximately 10 to 20% to conduct over-etching. A taper shape may be formed by etching the insulating layer 109 just once or by etching it for several times. A taper shape may be formed by conducting the second dry etching, further using CF₄, O₂, and He in a flow rate of CF₄ to be 550 sccm; a flow rate of O₂, 450 sccm; a flow rate of He, 350 sccm; a RF power, 3000 W; and a pressure, 25 Pa.

The gate insulating layer 105 is etched by the second etching to form an opening portion reaching the source region and the drain region. The opening portion may be formed by forming another mask after etching the insulating layer 109 or by etching the insulating film 108 and the gate insulating layer 105, using the etched insulating layer 109 as a mask. The gate insulating layer 105 is etched using CHF₃ and Ar as an etching gas. Through the etching according to the above conditions, the etching residue is reduced, and a contact hole having few depressions and highly flatness can be formed. Note that the etching time is preferably increased at a rate of approximately 10 to 20% in order to conduct etching without leaving a residue over the semiconductor layer.

A conductive film is formed and then etched to form a source or drain electrode layer 112 electrically connected to a part of each source or drain region. This source or drain electrode layer 112 is in contact with a later formed wiring or the like, and connects the thin film transistor to the wiring. The source or drain electrode layer 112 can be formed by forming a conductive film by PVD, CVD, vapor deposition, or the like, and etching the conductive film into a desired shape. The conductive layer can be selectively formed at a predetermined position by droplet discharge, printing, electroplating, or the like. Moreover, a reflow process or a damascene process can be used. As a material for the source or drain region layer 112, metal such as Ag, Au, Cu, Ni, Pt, Pd, Ir, Rh, W, Al, Ta, Mo, Cd, Zn, Fe, Ti, Si, Ge, Zr, or Ba; alloys of the foregoing metal; or metal nitride of the foregoing metal is used. In addition, a lamination structure of these materials may be adopted. In this embodiment mode, Ti, Al, and Ti are stacked and the lamination is patterned into a desired shape to form the source or drain electrode layer 112.

By the above-mentioned steps, a thin film transistor 150 having the second n-type impurity region 203a and the second n-type impurity region 203b which are high concentration impurity regions; the third n-type impurity region 206a and the third n-type impurity region 206b which are low concentration impurity regions; the second p-type impurity region 208, and the channel formation region 207 can be formed (FIG. 10E). In FIG. 10E, a width D2 of the second p-type impurity region 208 is preferably 5 to 200 nm, and a width of the third n-type impurity region 206a and the third n-type impurity region 206b is preferably 10 to 200 nm. A threshold value is shifted by setting the width D2 of the second p-type impurity region and the width D3 of the third n-type impurity region in the above described range and an n-channel thin film transistor capable of decreasing cut off current can be manufactured.

In this embodiment mode, a low concentration p-type impurity region is formed in an n-channel thin film transistor; however, a low concentration n-type impurity region may be formed in a p-channel thin film transistor in a similar way.

According to the following method, the thin film transistor 150 can be separated from the substrate 100 illustrated in FIGS. 10A to 10E. As a method for separating, (1) a method that uses a substrate having heat resistance at approximately 300 to 500° C. as the substrate 100, provides a metal oxide film between the substrate 100 and the thin film transistor 150, and makes the metal oxide film be fragile by crystallization of the metal oxide film to separate the thin film transistor 150; (2) a method that provides an amorphous silicon film containing hydrogen between the substrate 100 and the thin film transistor 150, and removes the amorphous silicon film by laser irradiation or etching with a gas or solution to separate the thin film transistor 150; (3) a method that removes mechanically the substrate 100 provided with the thin film transistor 150, or removes the thin film transistor 150 by etching with solution or gas such as CF₃ to separate the thin film transistor 150; or the like can be nominated. In addition, the separated thin film transistor 150 can be pasted to various materials for several purposes. For example, the thin film transistor 150 may be pasted onto a flexible substrate, using a commercially available adhesive agent, an adhesive agent such as an epoxy resin or a resin additive.

As noted above, by pasting the separated thin film transistor 150 onto the flexible substrate, a semiconductor device that is thin, lightweight, and hard to break when falling can be manufactured. Additionally, the flexible substrate has flexible property; therefore, the flexible substrate can be pasted to a curved surface and abnormally-shaped surface, thereby realizing a wide variety of uses. In addition, a semiconductor device with lower cost can be provided by the reuse of the substrate 100. The thin film transistor manufactured in this embodiment mode has a sidewall structure; therefore, an LDD region can be also formed in a thin film transistor having a submicron structure.

In this embodiment mode, a semiconductor layer is provided with an impurity region having an impurity element imparting a different conductivity type; therefore, properties of a thin film transistor can be minutely controlled. This enables a thin film transistor having required functions to be formed by brief steps and a semiconductor device with high reliability and better electrical characteristics to be manufactured at a low cost. In this embodiment mode, a thin film transistor is an n-channel thin film transistor having a low concentration p-type impurity region; therefore, a semiconductor device capable of high speed operation and reducing power consumption can be formed.

Additionally, the semiconductor device manufactured in this embodiment mode can be formed using a crystalline semiconductor film; therefore, the semiconductor device can be formed without using an expensive single crystal semiconductor substrate. Thus, cost can be reduced. In addition, the thin film transistor 150 manufactured in this embodiment mode is separated and then adhered to a flexible substrate, thereby enabling a thin semiconductor device to be manufactured.

This embodiment can be freely combined with Embodiment Mode 1 or Embodiment Mode 2.

### Embodiment Mode 4

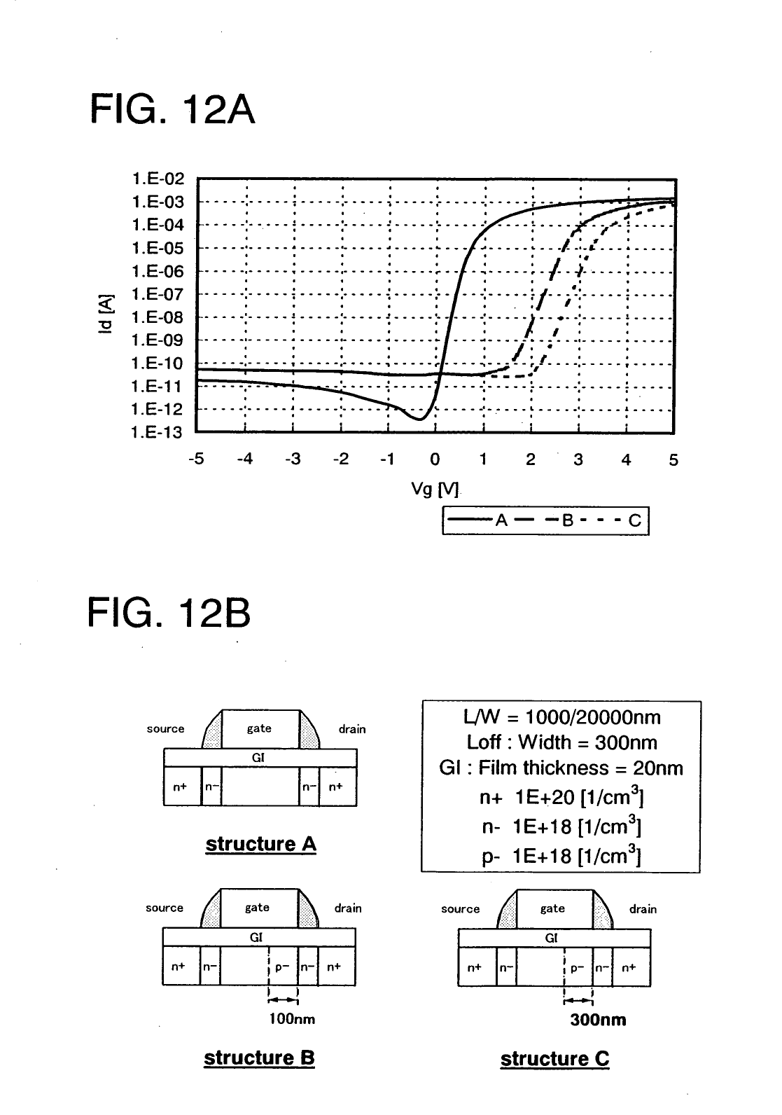

In Embodiment Mode 3, an example of forming a TFT having a second p-type impurity region 208 by doping in FIGS. 1A and 1B is shown, it is not specifically limited to this structure, and a total of eight-type structures including the structure shown in Embodiment Mode 3 can be obtained. Each of the structures is as follows: four types of n-channel thin film transistors (Structures B, C, D, and E) each having a n-channel thin film transistor (Structure A) low concentration p-type impurity region, and four types of p-channel thin film transistors (Structures G, H, I, and J) each having a p-channel thin film transistor (Structure F) low concentration n-type impurity region. Each structure of the thin film transistors is illustrated in FIGS. 12B, 13B, 14B, and 15B.

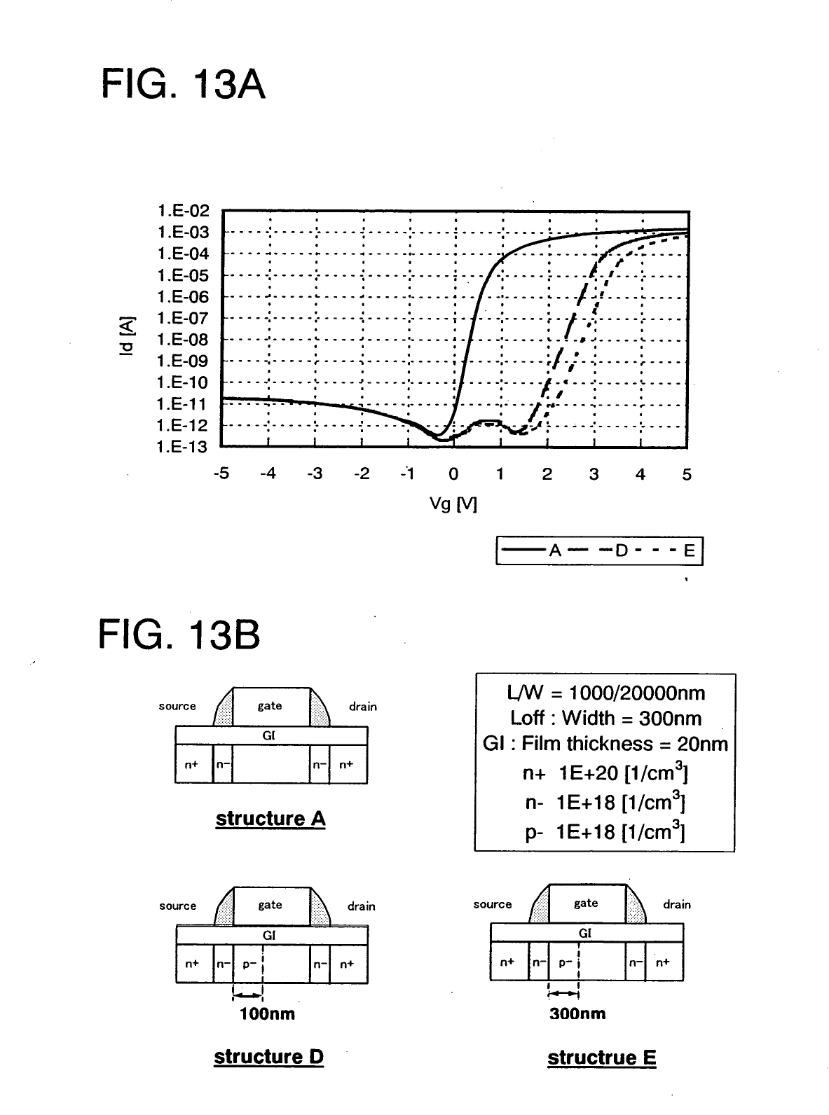

A simulation result of a current-voltage (I-V) characteristic of the n-channel thin film transistor having the low concentration p-type impurity region is described with reference to FIGS. 12A, 12B, 13A and 13B. FIG. 12A shows an I-V characteristic of an n-channel thin film transistor provided with a standard n-channel thin film transistor and a low concentration p-type impurity region (hereinafter p⁻) at its drain side by assuming a model diagram of a thin film transistor illustrated in FIG. 12B.

FIG. 12B shows each structure of the thin film transistors. Structure A is a standard n-channel thin film transistor having Loff, Structure B is an n-channel thin film transistor in which the width of p⁻ is 100 nm, and Structure C is an n-channel thin film transistor in which the width of p⁻ is 300 nm. Simulation of an I-V characteristic is performed in the conditions in each thin film transistor, that is, L/W is 1000/20000 nm, an Loff region width is 300 nm, a gate insulating film thickness is 20 nm, impurity concentration in source and drain regions (denoted by n⁺) is 1×10²⁰ cm⁻³, impurity concentration of Loff region is 1×10¹⁸ cm⁻³ and impurity concentration of p⁻ is 1×10¹⁸ cm⁻³.

In FIG. 12A, a full line indicates the I-V characteristic of Structure A and a broken line indicates the I-V characteristics of Structure B and Structure C having p−. Since Structure B and C have the p⁻, it is found that a threshold value is shifted to a positive side. Further, it can be found that the threshold value is shifted as the width of the p⁻ is increased (that is, the threshold value of Structure C is more shifted than that of Structure B).

FIGS. 13A and 13B show a simulation result of an I-V characteristic of a thin film transistor provided with a p⁻ at its source side. FIG. 13A shows an I-V characteristic of an n-channel thin film transistor provided with a standard n-channel thin film transistor and a low concentration p-type impurity region (hereinafter, p⁻) at its source side by assuming a model diagram of a thin film transistor illustrated in FIG. 13B.

FIG. 13B shows each structure of the thin film transistors. In FIG. 13B, Structure A is the same as the standard n-channel thin film transistor illustrated in FIG. 12B, Structure D is an n-channel thin film transistor having a p⁻ with a width of 100 nm, and Structure E is an n-channel thin film transistor having a p⁻ with a width of 300 nm. The value of the L/W, the Loff region width, the gate insulating film thickness, and n⁺ concentration are the same as those in FIGS. 12A and 12B.

In FIG. 13A, the full line indicates the I-V characteristic of Structure A and broken line indicates the I-V characteristics of Structure D and Structure E having p⁻. Since Structure D and E have the p⁻, it is found that a threshold value is shifted to a positive side. Further, it can be found that the threshold value is shifted as the width of the p⁻ is increased (that is, the threshold value of Structure E is more shifted than that of Structure D). Moreover, a cutoff current (Icut) is lowered than that of the standard n-channel thin film transistor. The cutoff current (Icut) is the value of a drain current Id at gate voltage Vg of 0 V in an Id-Vg characteristic.

As noted above, by using an n-channel thin film transistor having a low concentration p-type impurity region covered with a gate electrode and located between a channel formation region and either a source or a drain region, a threshold value is shifted and a cutoff current is reduced. Conventionally, a thin film transistor that is required to operate at high speed such as a CPU, a DRAM, an image processing circuit, or an audio processing circuit has a short channel structure; however, there is a problem that a short channel length causes the reduction of a threshold value and the increase of a cutoff current. A thin film transistor according to this embodiment can reduce a cutoff current despite of having a short channel structure. By using such the thin film transistor in all important positions in a semiconductor device, power consumption of the entire semiconductor device can be reduced. For instance, such the thin film transistor connected between a thin film transistor for logic and a power source to turn on in operating and turn off in non-operating, power consumption in a standby state can be reduced. Alternatively, by forming logic by the thin film transistor in a block that does not require high speed operation, power consumption of the entire semiconductor device can be reduced.

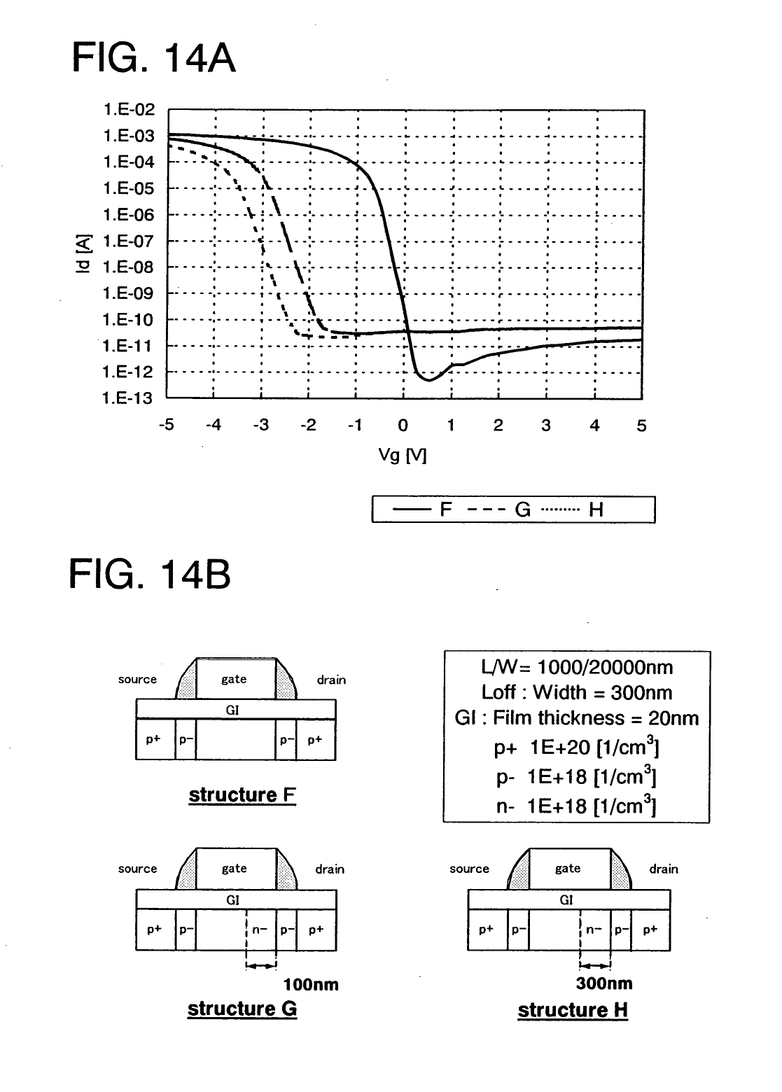

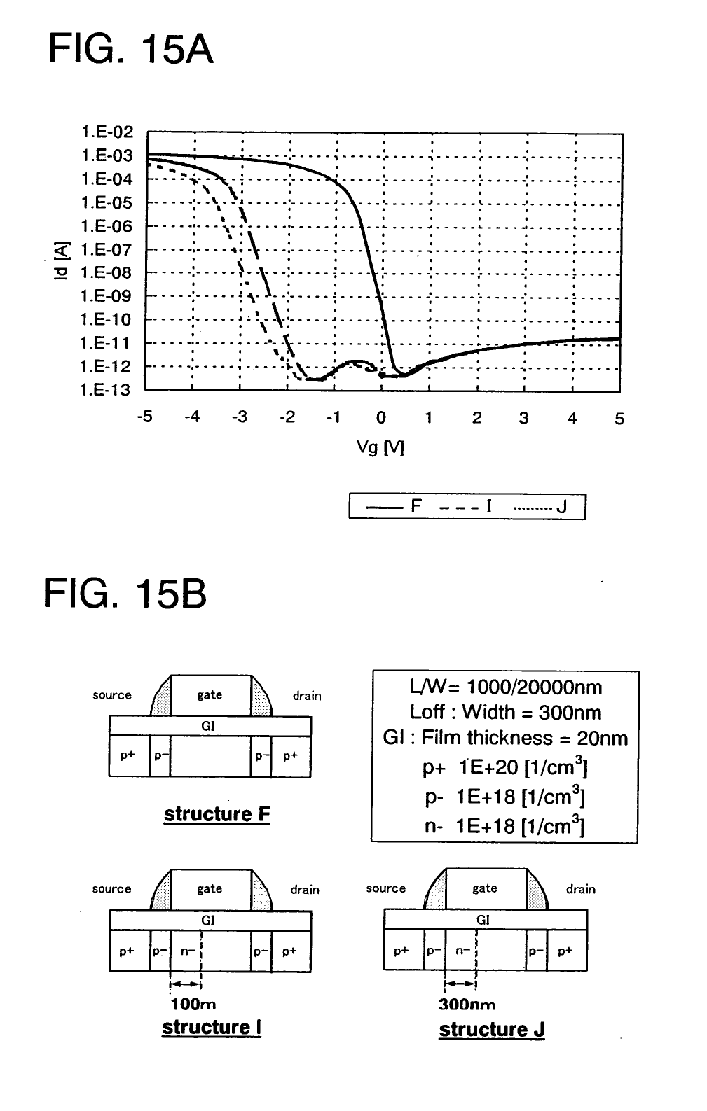

A simulation result of a current-voltage (I-V) characteristic of the p-channel thin film transistor having the low concentration n-type impurity region is described with reference to FIGS. 14A and 14B and FIGS. 15A and 15B. FIG. 14A shows an I-V characteristic of the p-channel thin film transistor provided with a standard p-channel thin film transistor and a low concentration n-type impurity region (hereinafter, n⁻) at its drain side by assuming a model diagram illustrated in FIG. 14B.

FIG. 14B shows each structure of the thin film transistors. Structure F is a standard p-channel thin film transistor having Loff, Structure G is a p-channel thin film transistor having an n⁻ with a width of 100 nm, and Structure H is a p-channel thin film transistor having an n⁻ with a width of 300 nm. Simulation of an I-V characteristic is performed in the conditions in each thin film transistor, that is, L/W is 1000/20000 nm, an Loff region width is 300 nm, a gate insulating film thickness is 20 nm, impurity concentration in source and drain regions (denoted by p⁺) is 1×10²⁰ cm⁻³, impurity concentration of the Loff region is 1×10¹⁸ cm⁻³, and impurity concentration of p⁻ is 1×10¹⁸ cm⁻³.

In FIG. 14A, a full line indicates an I-V characteristic of Structure F and a broken line indicates the I-V characteristics of Structure G and Structure H having n⁻. Since Structure G and H have the n⁻, it is found that a threshold value is shifted to a negative side. Further, it can be found that the threshold value is shifted as the width of the n⁻ is increased (that is, the threshold value of Structure H is more shifted than that of Structure G).

FIGS. 15A and 15B show a simulation result of an I-V characteristic of a p-channel thin film transistor provided with an n⁻ at its source side. FIG. 15A shows an I-V characteristic of a p-channel thin film transistor provided with a standard p-channel thin film transistor and a low concentration n-type impurity region (hereinafter, n⁻) at its source side by assuming a model diagram illustrated in FIG. 15B.

FIG. 15B shows each structure of thin film transistors. Structure G is the same as the standard p-channel thin film transistor illustrated in FIG. 15B, Structure I is a p-channel thin film transistor having an n⁻ with a width of 100 nm, and Structure J is a p-channel thin film transistor having an n⁻ with a width of 300 nm. The value of the L/W, the Loff region width, the gate insulating layer thickness, and p⁺ concentration are the same as those in FIGS. 14A and 14B.

In FIG. 15A, a full line indicates the I-V characteristic of Structure F and a broken line indicates the I-V characteristics of Structure I and Structure J having n⁻. Since Structure I and J have the n⁻, it is found that a threshold value is shifted to a negative side. Further, it can be found that the threshold value is shifted as the width of the n− is increased (that is, the threshold value of Structure J is more shifted than that of Structure I). Moreover, a cutoff current (Icut) is lowered than that of the standard p-channel thin film transistor. That is, high speed operation and reducing power consumption are possible and as well as the case of using the n-channel thin film transistor.

This embodiment can be freely combined with any one of Embodiment Mode 1 to 3.

### Embodiment Mode 5

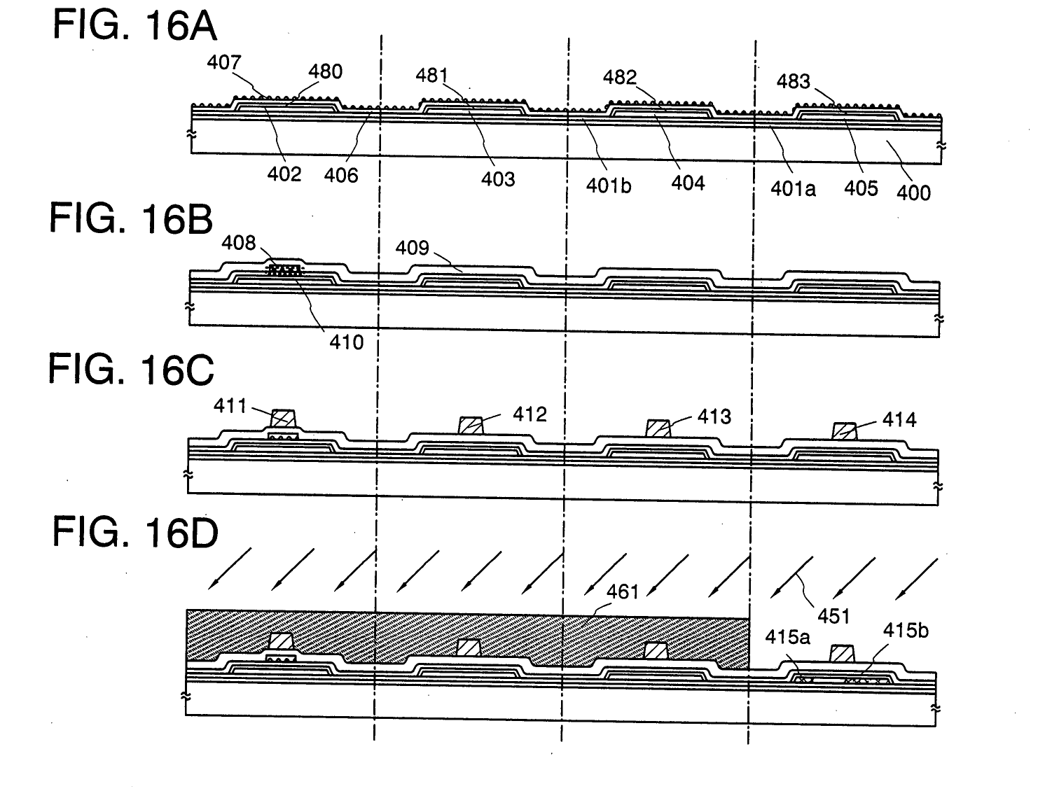

An embodiment mode of the invention is described with reference to FIG. 16A to FIG. 19B. This embodiment mode describes an example where a semiconductor nonvolatile memory element (hereinafter, referred to as a memory-transistor) is formed in a semiconductor device having a thin film transistor manufactured in Embodiment Mode 3. Then, repeated descriptions of the same portion and the portion having the same function are omitted.

As well as Embodiment Mode 3, a base film 401a and a base film 401b are stacked as a base film over a substrate 400 and then a semiconductor layer 402, a semiconductor layer 403, a semiconductor layer 404, and a semiconductor layer 405 are formed. An amorphous semiconductor film is irradiated with laser light to be crystallized, and then a formed crystalline semiconductor film is patterned to form the semiconductor layer 402, the semiconductor layer 403, the semiconductor layer 404, and the semiconductor layer 405. In this embodiment mode, silicon is used as a material for the semiconductor layer, and a crystalline silicon film having a crystal grain continuously grown is formed by irradiating an amorphous silicon film. Note that the semiconductor layer 402, the semiconductor layer 403, the semiconductor layer 404, and the semiconductor layer 405 are formed so that a channel formation region of a subsequently formed thin film transistor is formed parallel to the scanning direction of the laser light. In this embodiment mode, pulsed laser light at a repetition rate of 80 MHz is used as a laser light. A crystal grain of a single crystal which is long extended along a scanning direction of the laser light is formed, thereby becoming it possible to form a semiconductor film having little crystal grain boundary at least which prevents a carrier of a thin film transistor from moving.

An insulating film 480, an insulating film 481, an insulating film 482, and an insulating film 483 are formed over the semiconductor layer 402, the semiconductor layer 403, the semiconductor layer 404, the semiconductor layer 405, and the substrate 400, and then an insulating film 406 is formed thereon. The lamination of the insulating film 480, the insulating film 481, the insulating film 482, the insulating film 483, and the insulating film 406 formed thereon is preferably formed to have a thickness of 1 to 100 nm, more preferably, 1 to 10 nm, further more preferably, 2 to 5 nm. The insulating film 480, the insulating film 481, the insulating film 482, the insulating film 483, and the insulating film 406 formed thereon serve as a tunnel oxide film in a memory transistor and as a part of a gate insulating film in a thin film transistor. Accordingly, a tunnel current is easier to flow when thicknesses of the insulating film 480, the insulating film 481, the insulating film 482, the insulating film 483, and the insulating film 406 formed thereon are thinner, it is preferable since high speed operation becomes possible. The thinner the thickness of the insulating film 480, the insulating film 481, the insulating film 482, the insulating film 483, and the insulating film 406 formed thereon is, the lower the voltage required to store charges in the floating gate electrode is. As a result, power consumption of a semiconductor device that is formed afterwards can be reduced.

As a method for forming the insulating film 480, the insulating film 481, the insulating film 482, and the insulating film 483, GRTA, LRTA, or the like is used to oxidize a surface of the semiconductor region to form a thermal oxide film, and an insulating film having a thin thickness can be formed. Alternatively, CVD, coating, or the like can be used. As the insulating film 406, a silicon oxide film, a silicon nitride film, a silicon oxynitride film, or a silicon nitride oxide can be used. Further, the insulating film 406 may be formed to have a lamination structure formed by stacking a silicon oxide film and a silicon nitride film over the substrate 400, or stacking a silicon oxide film, a silicon nitride film, and a silicon oxide film over the substrate 400.

In this embodiment mode, silicon oxide films are formed as the insulating film 480, the insulating film 481, the insulating film 482, and the insulating film 483, and a silicon nitride film is formed as the insulating film 406. After removing natural oxidation films formed on the surface of the semiconductor layer 402, the semiconductor layer 403, the semiconductor layer 404, and the semiconductor layer 405, the semiconductor layers 402 to 405 are exposed to ozone water containing hydroxyl radical for several ten seconds to several minutes and silicon oxide films are formed on the surfaces of the semiconductor layer 402, the semiconductor layer 403, the semiconductor layer 404, the semiconductor layer 405. Then, silicon oxide films are made minute by GRTA and the insulating film 480, the insulating film 481, the insulating film 482, and the insulating film 483 are formed to each have a film thickness of 1 to 2 nm. The method enables the process to be conducted for short time and at high heat; therefore, a minute and thin insulating film can be formed without expanding and contracting the substrate. Next, a silicon nitride oxide film is formed to have a film thickness of 1 to 5 nm over the silicon oxide film as the insulating film 406.

Conductive particles or semiconductor particles (hereinafter, disperse particles) 407 that are dispersed over the insulating film 406 are formed (FIG. 16A). As a manufacturing method for the disperse particles, a known method such as sputtering, plasma CVD, LPCVD, vapor deposition, or droplet discharge can be used. Since the insulating film 406 can be buffered when forming the disperse particles by plasma CVD, LPCVD, vapor deposition, or droplet discharge, defects of the insulating film 406 can be prevented from generating. As a result, a semiconductor device having high reliability can be manufactured. The disperse particles can be formed after forming a conductive film or a semiconductor film by the foregoing method and being etched into a desired shape. The size of each disperse particle is 0.1 to 10 nm, preferably, 2 to 5 nm. As a material for conductive particles, gold, silver, copper, palladium, platinum, cobalt, tungsten, nickel, and the like can be used. As a material for semiconductor particles, silicon (Si), germanium (Ge), or silicon germanium alloy, and the like can be used. In this embodiment mode, here, silicon microcrystal is formed as the disperse particles 407 by plasma CVD (FIG. 16A).

An insulating film is formed over the disperse particles 407 and the insulating film 406. As the insulating film, a silicon nitride film or a silicon nitride oxide film is formed to have a film thickness of 10 to 20 nm by plasma CVD.

Next, a mask is formed on the disperse particles 407 over the semiconductor layer 402 to be a memory transistor.

A part of the disperse particles 407 are etched using the mask and an insulating film 408 having a floating gate electrode 410 is formed. As a method of removing the insulating film and the disperse particles 407, known etching such as dry etching or wet etching can be used. In this embodiment mode, the insulating film is removed by dry etching to expose the disperse particles 407. When a dry etching is used in the case that the thickness of the insulating film 406 provided with the disperse particles 407 is thin, there is a possibility of generating defects in the insulating film 406 by plasma bombardment. Accordingly, the disperse particles 407 are preferably removed by wet etching. Here, silicon microcrystals that are the disperse particles are removed by wet etching using NMD₃ solution (water solution containing 0.2 to 0.5% of tetramethyl ammonium hydrooxide).

The floating gate electrode comprises dispersed particles. Accordingly, in the case that a defect occurs in the insulating film 406 serving as a tunnel oxide film, all charges stored in the floating gate electrode can be prevented from flowing out from the defect to the semiconductor region. As a result, a semiconductor memory transistor having high reliability can be manufactured.

After removing the mask, an insulating film 409 is formed over the insulating film 406 and the insulating film 408 including the floating gate electrode 410 (FIG. 16B). The insulating film 409 is preferably formed to have a thickness of 1 to 100 nm, more preferably, 10 to 70 nm, and further more preferably 10 to 30 nm. The insulating film 409 is required to keep electrical isolation from the floating gate electrode 410 and a gate electrode layer that is formed afterwards in the memory transistor. Accordingly, it is preferable that the insulating film 409 is formed to have a thickness that does not allow a leak current to increase. The insulating film 409 can be formed by a silicon oxide film, a silicon nitride film, a silicon oxynitride film, or a silicon nitride oxide film as with the insulating film 406. Alternatively, the insulating film 409 may be formed to have a lamination layer structure formed by stacking a silicon oxide film and a silicon nitride film over the substrate 400, or stacking a silicon oxide film, a silicon nitride film, and a silicon oxide film over the substrate 400. The silicon oxide film is preferably formed on the semiconductor region since an interface state between the gate insulating film and the semiconductor region is lowered. Here, a lamination layer structure is formed by stacking a silicon oxide film with a thickness of 10 nm and a silicon nitride film with a thickness of 20 nm as the insulating film 409.

After forming the insulating film 409, the disperse particles and the mask pattern that cover the disperse particles are formed, and a second floating gate electrode may be formed. Moreover, a plurality of the floating gate electrode can be stacked by repeating the similar processes.

A conductive film comprising tungsten (W) is formed over the insulating film 409. In this embodiment mode, the tungsten (W) is used as a gate electrode layer. The conductive film is etched to be a thin line, thereby forming a gate electrode layer 411, a gate electrode layer 412, a gate electrode layer 413, and a gate electrode layer 414 (FIG. 16C). Then, a mask 461 comprising a resist is formed to cover the semiconductor layer 402, the semiconductor layer 403, and the semiconductor layer 404.

The semiconductor layer 405 is doped with an impurity element 451 imparting p-type obliquely to the surface thereof using the gate electrode layer 414 as a mask by using the doping device shown in FIGS. 1A and 1B. Therefore, a first p-type impurity region 415a and a first p-type impurity region 415b are formed (FIG. 16D). For simplification, a substrate which is placed horizontally is shown in FIG. 16D, practically, doping is conducted while the substrate is inclined and moved in one direction. Since the semiconductor layer is obliquely doped with the impurity element 451 imparting p-type, the first p-type impurity region 415b is also formed in a portion covered with the gate electrode layer 414 in the semiconductor layer 405. However, the impurity element 451 imparting p-type is blocked by the gate electrode layer 414 which functions as a mask; therefore, the first p-type impurity region 415a is not formed in the portion formed below the first gate electrode layer 414 in the semiconductor layer 405. Here, the doping is conducted so that the first p-type impurity region 415a and the first p-type impurity region 415b include the impurity elements imparting p-type to be a concentration of approximately 5×10¹⁷ to 5×10¹⁸/cm³. In addition, the concentration thereof may be set at approximately 5×10¹⁶ to 1×10¹⁷/cm³. In this embodiment mode, boron (B) is used as the impurity elements imparting p-type.

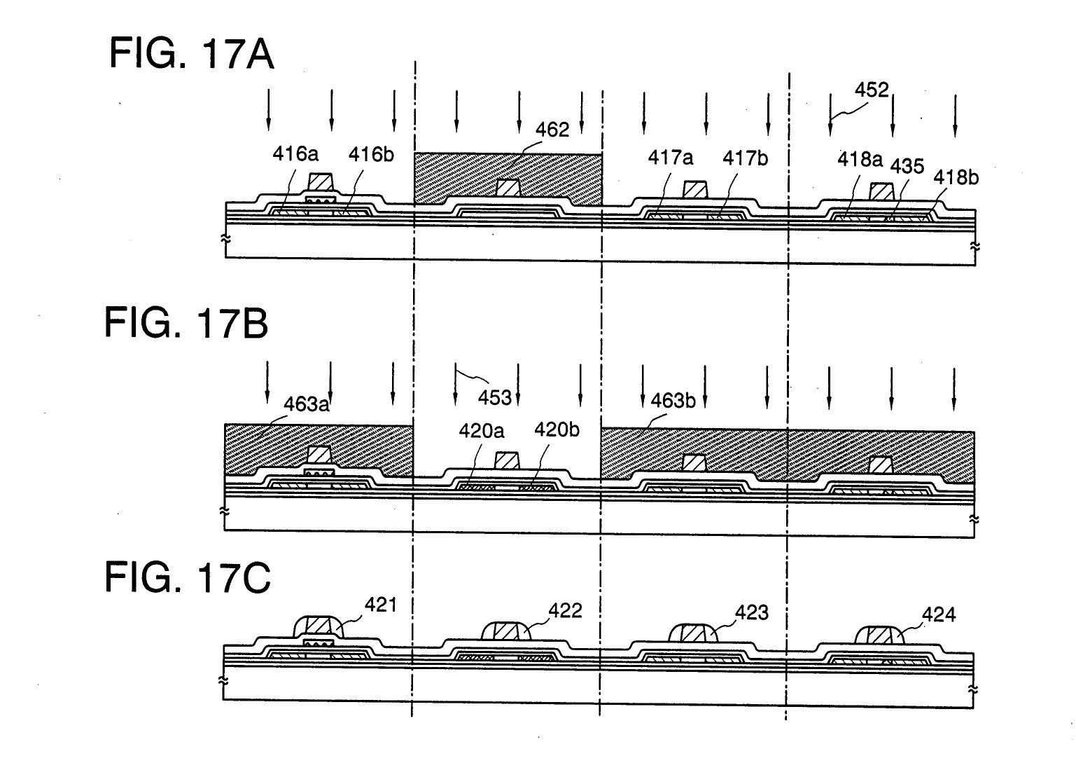

The mask 461 is removed and then a mask 462 comprising a resist is formed so to cover the semiconductor layer 403. The mask 462 may be formed newly or formed by processing the mask 461. The semiconductor layer 402, the semiconductor layer 404, and the semiconductor layer 405 are doped with an impurity element imparting n-type perpendicular to the surfaces thereof, using the gate electrode layer 411, the gate electrode 413, and the gate electrode layer 414 as a mask, thereby forming a first n-type impurity region 416a, a first n-type impurity region 416b, a first n-type impurity region 417a, a first n-type impurity region 417b, a first n-type impurity region 418a and a first n-type impurity region 418b (FIG. 17A). Since the first p-type impurity region 415a and the first p-type impurity region 415b have been doped with the impurity element imparting p-type, portions of them are doped with impurity elements imparting n-type in order to be changed into an n-type impurity region. The first n-type impurity region 416a, the first n-type impurity region 416b, the first n-type impurity region 417a, the first n-type impurity region 417b, the first n-type impurity region 418a and the first n-type impurity region 418b are formed to include the impurity elements imparting n-type typically in a concentration of 1×10¹⁷ to 5×10¹⁸/cm³. In this embodiment mode, phosphorous (P) is used as the impurity elements imparting n-type. Regions covered with the gate electrode layer 411, the gate electrode layer 413, and the gate electrode layer 414 in the semiconductor layer 402, the semiconductor layer 404, and the semiconductor layer 405 are not doped by being blocked by the gate electrode layers 411, 413, and 414, since the impurity elements 452 imparting n-type is added perpendicularly. Therefore, a part of the first p-type impurity region formed in a semiconductor layer under the gate electrode 414 is left, and becomes a second p-type impurity region 435. The second p-type impurity region 435 is formed as an Lov region.

A mask 462 is removed by etching or the like to form masks 463a and 463b to cover the semiconductor layers 402, 404, and 405. The semiconductor layer 403 is doped with an impurity element 453 imparting p-type perpendicularly to the surface thereof, using the mask 463a, the mask 463b, and the gate electrode layer 412 as a mask, thereby forming a third p-type impurity region 420a and a third p-type impurity region 420b (FIG. 17B). Here, doping is conducted so that the third p-type impurity region 420a and the third p-type impurity region 420b include the impurity elements imparting p-type to be a concentration of approximately 1×10²⁰ to 5×10²¹/cm³. In this embodiment mode, boron (B) is used as the impurity element imparting p-type.

The mask 463a and the mask 463b are removed by etching or the like. An insulating layer is formed over the insulating film 409, the gate electrode layer 411, the gate electrode layer 412, and the gate electrode layer 413, and the gate electrode layer 414, and anisotropic etching is conducted, thereby forming a sidewall 421, a sidewall 422, a sidewall 423, and a sidewall 424 on side surfaces of the gate electrode layer 411, the gate electrode layer 412, the gate electrode layer 413, and the gate electrode layer 414 (FIG. 17C). In this embodiment mode, silicon oxide is used as the insulating layer for forming the sidewalls. When the sidewall 421, the sidewall 422, the sidewall 423, and the sidewall 424 are formed, the insulating layer may be left over the gate electrode layer 411, the gate electrode layer 412, the gate electrode layer 413, and the gate electrode layer 414, or a protective film may formed over the gate electrode layers.

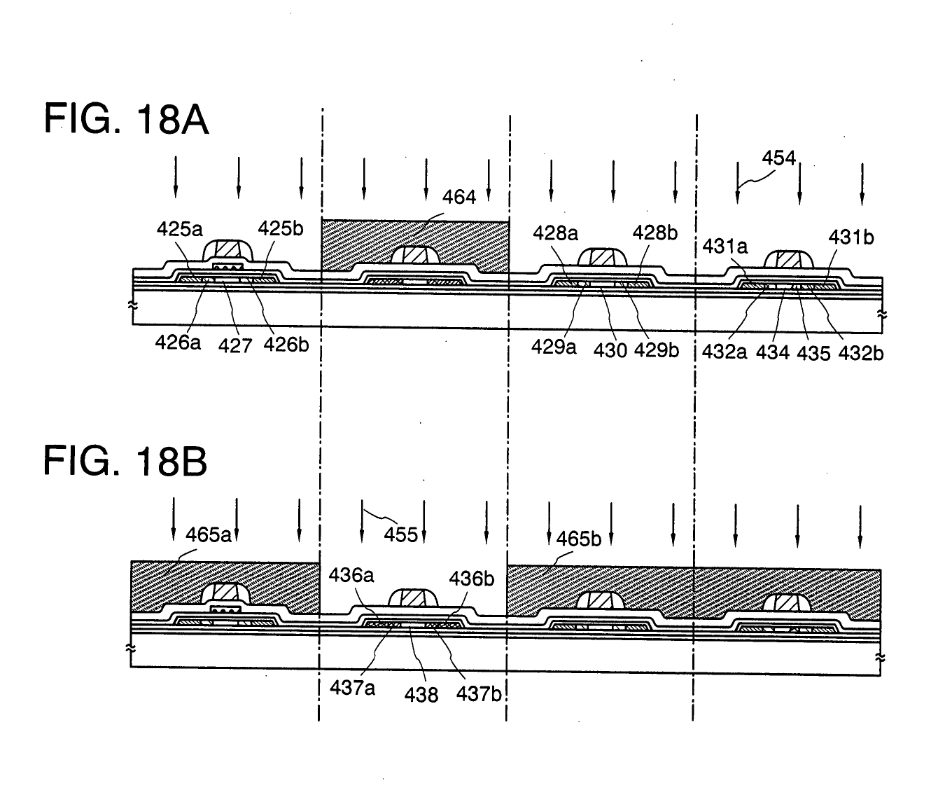

A mask 464 comprising a resist is formed to cover the semiconductor layer 403. The semiconductor layer 402, the semiconductor layer 404, and the semiconductor layer 405 are doped with an impurity element 454 imparting n-type perpendicular to the surfaces thereof, using the sidewall 421, the sidewall 423, the sidewall 424, the gate electrode layer 411, the gate electrode layer 413, and the gate electrode layer 414 as a mask, thereby forming a second n-type impurity region 425a, a second n-type impurity region 425b, a second n-type impurity region 428a, a second n-type impurity region 428b, a second n-type impurity region 431a, and a second n-type impurity region 431b (FIG. 18A). Portions of the semiconductor layers which are covered with the side walls are not doped with the impurity element 454 imparting n-type; therefore, they become a third n-type impurity region 426a, a third n-type impurity region 426b, a third n-type impurity region 429a, a third n-type impurity region 429b, a third n-type impurity region 432a, and a third n-type impurity region 432b. The second n-type impurity region 425a, the second n-type impurity region 425b, the second n-type impurity region 428a, the second n-type impurity region 428b, the second n-type impurity region 431a, and the second n-type impurity region 431b are high concentration impurity regions; therefore, each of them functions as a source region or a drain region. The second n-type impurity region 425a, the second n-type impurity region 425b, the second n-type impurity region 428a, the second n-type impurity region 428b, the second n-type impurity region 431a, and the second n-type impurity region 431b include the impurity elements imparting n-type at a concentration of approximately 5×10¹⁹ to 5×10²⁰/cm³. In this embodiment mode, phosphorous (P) is used as the impurity element imparting n-type.

On the other hand, the third n-type impurity region 426a, the third n-type impurity region 426b, the third n-type impurity region 429a, the third n-type impurity region 429b, the third n-type impurity region 432a, and the third n-type impurity region 432b which are low concentration impurity regions, are formed of Loff regions which are not covered with the gate electrode layer 411, the gate electrode 413, and the gate electrode layer 414. Therefore, an electric field adjacent to a drain can be relieved, deterioration due to hot carrier injection can be prevented, and off-current can be reduced. Hereby, a semiconductor device with high reliability and low power consumption can be formed. Note that a channel formation region 427, a channel formation region 430, and a channel formation region 434 are formed in the semiconductor layer 402, the semiconductor layer 404, and the semiconductor layer 405.

A mask 465a and a mask 465b comprising resists is formed to cover the semiconductor layer 402, the semiconductor layer 404, and the semiconductor layer 405. The semiconductor layer 403 is doped with an impurity element 455 imparting p-type perpendicularly to the surface thereof, using the mask 465a, the mask 465b, the sidewall 422, and the gate electrode layer 412 as masks, thereby forming a fourth p-type impurity region 436a, a fourth p-type impurity region 436b, a fifth p-type impurity region 437a, and a fifth p-type impurity region 437b (FIG. 18B). Here, the doping is conducted so that the fourth p-type impurity region 436a and the fourth p-type impurity region 436b include the impurity elements imparting p-type to be a concentration of approximately 1×10²⁰ to 5×10²¹/cm³. And doping is conducted so that the fifth p-type impurity region 337a and the fifth p-type impurity region 337b include the impurity elements imparting p-type to be a concentration of approximately 5×10¹⁸ to 5×10¹⁹/cm³. In this embodiment mode, boron (B) is used as the impurity element imparting p-type. Note that a channel formation region 438 is formed in the semiconductor layer 403.

The fourth p-type impurity region 436a and the fourth p-type impurity region is 436b are high concentration impurity regions, and each of them functions as a source region or a drain region. On the other hand, the fifth p-type impurity region 437a and the fifth p-type impurity region 437b, which are low concentration p-type impurity regions, are formed of Loff regions which are not covered with a gate electrode layer. An electric field adjacent to a drain can be relieved and deterioration due to hot carrier injection can be prevented, and additionally, off-state current can be reduced, since the fifth p-type impurity region 437a and the fifth p-type impurity region 437b are not covered with the gate electrode layer. Hereby, a semiconductor device with high reliability and low power consumption can be manufactured.

Heat treatment, laser irradiation, or the like is performed for activating an impurity element and an insulating film 443 for hydrogenation is formed arbitrarily. Hydrogenation is conducted by heat treatment and an insulating layer 446 is formed. The heat treatment for activating an impurity element may be conducted in conjunction with the heat treatment for hydrogenation; therefore, processes can be simplified. In this embodiment mode, a silicon nitride oxide film and a silicon oxynitride film are stacked in order as the insulating layer 446 to have a lamination structure.

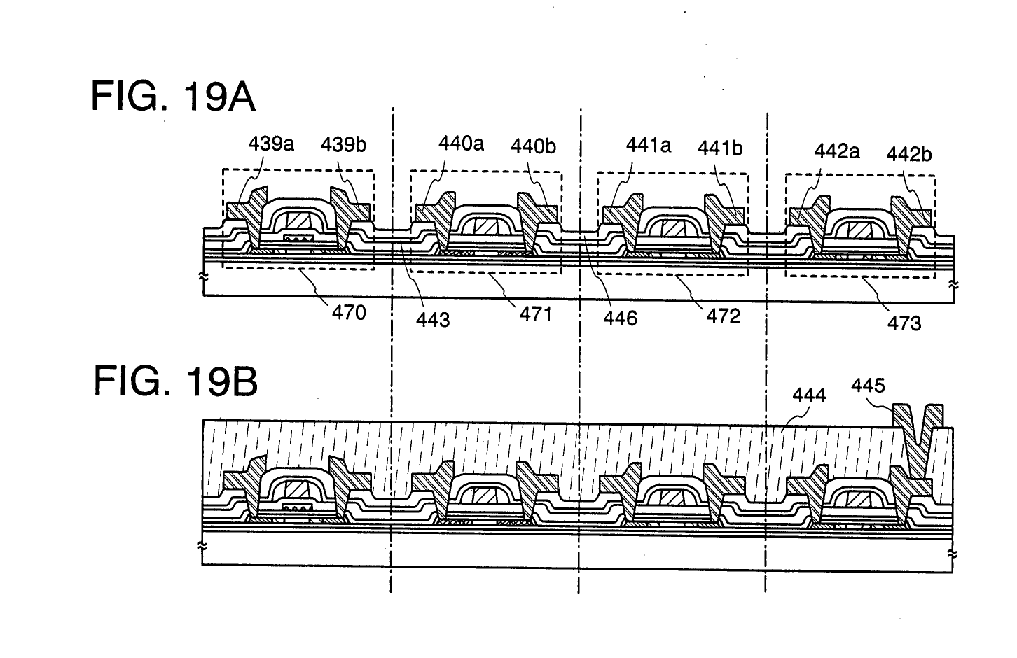

Opening portions (contact holes) reaching a source region and a drain region are formed in the insulating layer 446, the insulating film 443, the insulating film 406, the insulating film 409, the insulating film 480, the insulating film 481, the insulating film 482, and the insulating film 483. A source or drain electrode layer 440a, a source or drain electrode layer 440b, a source or drain electrode layer 441a, a source or drain electrode layer 441b, a source or drain electrode layer 442a, a source or drain electrode layer 442b, a source or drain electrode layer 439a, and a source or drain electrode layer 439b which are in contact with the source region or the drain region are formed in the opening portions (FIG. 19A). In this embodiment mode, aluminum (Al), titanium (Ti), and aluminum (Al) stacked as the source electrode layer or the drain electrode layer is used.

In addition, as shown in FIG. 19B, an insulating layer 444 having an opening portion reaching the source electrode layer or the drain electrode layer are formed over the source electrode layer or the drain electrode layer and a wiring layer 445 may be formed in the opening portion. In this embodiment mode, an insulating layer containing siloxane polymer is used for the insulating layer 444, and a lamination of aluminum (Al) and titanium (Ti) is used for the wiring layer 445.

A semiconductor device providing the same substrate with a memory transistor 470, a p-channel thin film transistor 471, an n-channel thin film transistor 472, and an n-channel thin film transistor 473 having a low concentration p-type impurity region can be formed. Each of the memory transistor and the thin film transistors of the semiconductor device in this embodiment mode is formed using a semiconductor region having little crystal grain boundary in a channel direction; therefore, high speed operation can be performed. Additionally, the semiconductor device has the n-channel thin film transistor having a low concentration p-type impurity region; therefore, a semiconductor device such as an ID chip or the like capable of high speed operation and reducing power consumption can be formed.

In addition, the p-channel thin film transistor 471, the n-channel thin film transistor 472, and the n-channel thin film transistor having a low concentration p-type impurity region 473 are formed using a lamination of the insulating film 481, the insulating film 482, and the insulating film 483 which are formed over the surfaces of the semiconductor layers, the insulating layer 406, and the insulating layer 409 which are formed thereon, as a gate insulating layer. Therefore, a thin film transistor can have high pressure resistance. Alternately, when the insulating film 409 is removed, and the gate insulating layer is formed of a lamination of the insulating film 481, the insulating film 482, and the insulating film 483 and the insulating film 406 which is formed thereover, a thin film transistor capable of high speed operation can be formed. In this way, a thin film transistor having properties capable of responding to required functions can be formed and a semiconductor device can be manufactured.

According to the invention, a semiconductor layer is provided with an impurity region having an impurity element imparting a different conductivity type; therefore, properties of a thin film transistor can be minutely controlled. This enables a thin film transistor having required functions to be formed by brief steps and a semiconductor device with high reliability and better electrical characteristics to be manufactured at a low cost. That is, a functional circuit or the like which emphasizes a high speed operation, such as a CPU, a DRAM, an image processing circuit, and an audio processing circuit and a driver circuit or the like which emphasizes high pressure resistance, such as a buffer circuit, a shift register circuit, a level shifter circuit, and a sampling circuit can be formed over the same substrate. Thus, a semiconductor device such as a system LSI, having an element of various functions and structures can be manufactured over the same substrate.

This embodiment mode can be implemented in combination with each of Embodiment Modes 1 to 4.

### Embodiment Mode 6

One of semiconductor devices which can be manufactured according to a manufacturing method of a semiconductor device by using a doping device of the present invention is an ID chip. An ID chip is a semiconductor device which can wirelessly transmit/receive data such as identifying information, and has been developed for practical use. An ID chip is also referred to as a wireless tag, a RFID (radio frequency identification) tag, an IC tag, or the like. Further, an ID chip using a glass substrate can be referred to as an IDG chip (identification glass chip), and an ID chip using a flexible substrate can be referred to as an IDF chip (identification flexible chip). The present invention can be applied to either of them.

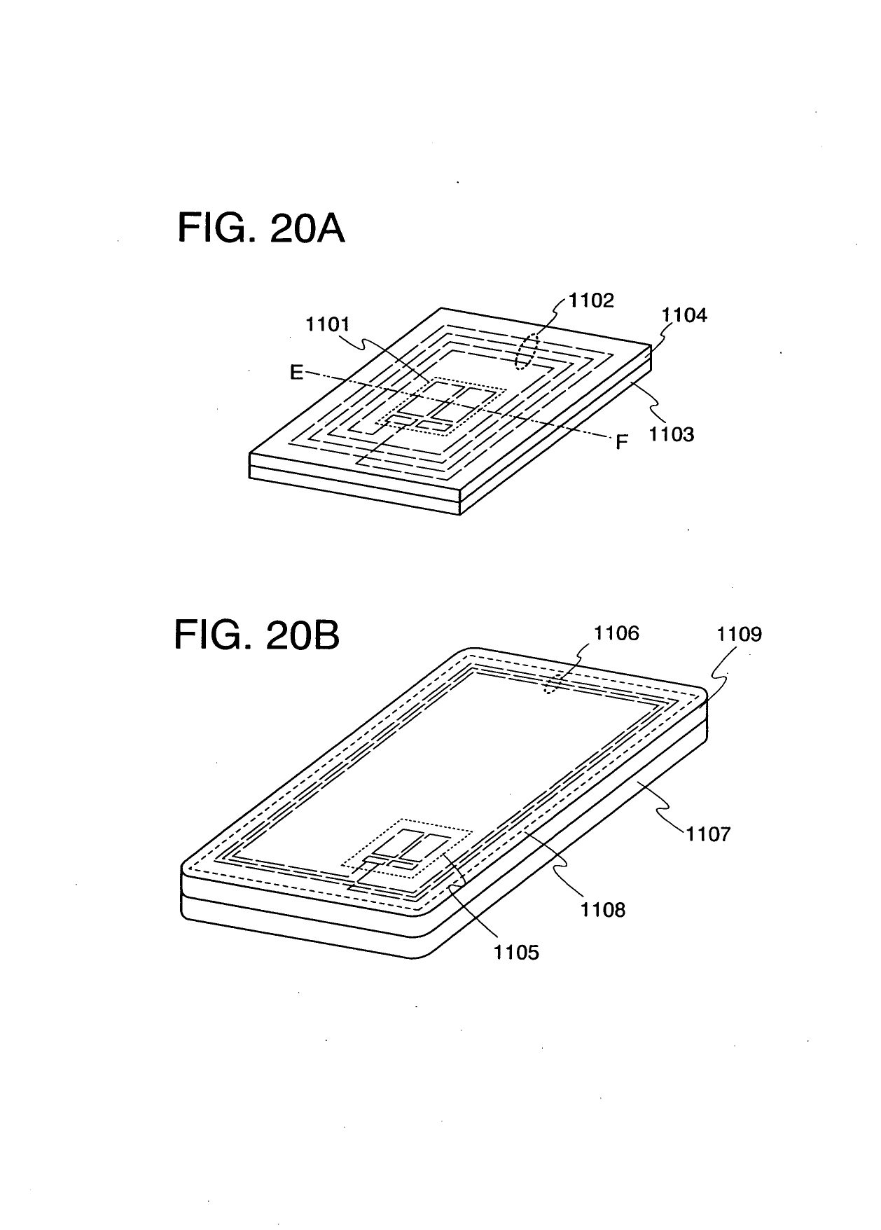

FIG. 20A is a perspective view showing one mode of an ID chip that is one of the semiconductor devices. Reference numeral 1101 denotes an integrated circuit, and 1102 denotes an antenna that is connected to the integrated circuit 1101. Reference numeral 1103 denotes a support which also functions as a cover material and 1104 denotes a cover material. The integrated circuit 1101 and the antenna 1102 are formed over the support 1103, and the cover material 1104 overlaps the support 1103 so as to cover the integrated circuit 1101 and the antenna 1102. However, the cover material 1104 is not necessarily used; the mechanical strength of the ID chip can be increased by covering the integrated circuit 1101 and the antenna 1102 with the cover material 1104.

FIG. 20B is a perspective view showing one mode of an IC card that is one of the semiconductor devices. Reference numeral 1105 denotes an integrated circuit, and 1106 denotes an antenna that is connected to the integrated circuit 1105. Reference numeral 1108 denotes a substrate functioning as an inlet sheet and 1107 and 1109 denote cover materials. The integrated circuit 1105 and the antenna 1106 are formed over the substrate 1108, and the substrate 1108 is sandwiched between the two cover materials 1107 and 1109. The IC card may have a display device connected to the integrated circuit 1105.

In this embodiment mode, an example where an integrated circuit and a lamination body having an antenna formed over an interlayer insulating film of the integrated circuit are adhered by different cover materials is shown; however, it is not limited to this, the integrated circuit may be adhered to a cover film provided with an antenna by using an adhesive. In this, time, an integrated circuit is adhered to an antenna by conducting UV treatment or ultrasonication by using an anisotropic conductive adhesive or an anisotropic conductive film; however, the invention can use various methods without being limited by this method.

The support 1103 and the cover film 1104 can be formed of a material having flexibility such as plastic, an organic resin, a paper, a fiber, carbon graphite, or the like. By using a biodegradable resin for a cover material, it is disassembled by bacteria, and it is returned to soil. Also, since the integrated circuit of this embodiment mode comprises silicon, aluminum, oxygen, nitrogen, or the like, a nonpolluting ID chip can be formed. Additionally, a used ID chip can be burnt up or cut by using a cover film comprising an incineration nonpolluting material such as paper, fiber, carbon graphite. In addition, an ID chip using these materials is nonpolluting, since it does not generate a poisonous gas either even when it is burnt up.

It is preferably to form the integrated circuit 1101 sandwiched between the support 1103 and the cover material 1104 with a thickness of 5 μm or less, more preferably, 0.1 μm to 3 μm. Additionally, when the total thickness of the support 1103 and the cover material 1104 is denoted by d, each thickness of the support 1103 and the cover material 1104 is preferably (d/2)±30 μm, more preferably, (d/2)±10 μm. Further, the support 1103 and the cover material 1104 are preferably formed to have thicknesses of 10 μm to 200 μm. Moreover, the area of the integrated circuit 1101 is 5 mm square (25 mm²) or less, preferably, 0.3 to 4 mm square (0.09 mm² to 16 mm²).

Since the support 1103 and the cover material 1104 are made from organic resin materials, they have a high property with respect to bending. The integrated circuit 1101 itself formed by a peeling process has a high property with respect to bending compared to a single crystalline semiconductor. Since the integrated circuit 1101, the support 1103, and the cover material 1104 can be adhered together with no space between them, the complete ID chip itself has a high property with respect to bending. The integrated circuit 1101 surrounded by the support 1103 and the cover material 1104 may be placed over the surface or interior of another material or embedded in a paper.

In this embodiment mode, an example where an integrated circuit and a lamination body having an antenna formed over an interlayer insulating film of the integrated circuit are adhered by different cover materials is shown; however, it is not limited to this, the integrated circuit may be adhered to a cover material provided with an antenna by using an adhesive. In this time, an integrated circuit is adhered to an antenna by conducting UV treatment or ultrasonication by using an anisotropic conductive adhesive or an anisotropic conductive film; however, the invention can use various methods without being limited by this method. Additionally, an antenna does not have to be always equal with the size of an ID chip, and it may be bigger or may be smaller and is set suitably. In addition, transmitting or receiving a signal can use electromagnetic wave of radio, light, or the like.

This embodiment mode can be freely combined with any one of Embodiment 1 to 5.

### Embodiment Mode 7

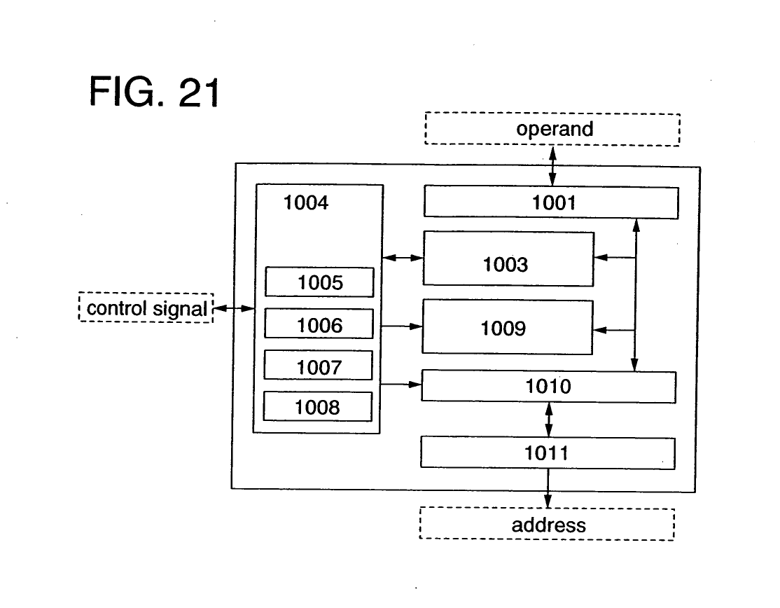

A block diagram of one chip of a processor such as CPU typified by a semiconductor device or the like is described with reference to FIG. 21.

On inputting an operation code to a data bus interface 1001, the code is decoded by an analysis circuit 1003 (also referred to as Instruction Decoder), and a signal is inputted to a control signal generation circuit 1004 (CPU Timing Control). On inputting the signal, a control signal is outputted from the control signal generation circuit 1004 to an arithmetic circuit 1009 (ALU) and to a storage circuit 1010 (Register).

The control signal generation circuit 1004 comprises an ALU controller 1005 (ACON) for controlling the ALU 1009, a circuit 1006 (RCON) for controlling the Register 1010, a timing controller 1007 (TCON) for controlling timing, and an interruption controller 1008 (ICON) for controlling interruption.

On inputting an operand to the data bus interface 1001, the operand is outputted to the ALU 1009 and the Register 1010. Then, a process based on a control signal inputted from the control signal generation circuit 1004 (for example, memory read cycle, memory write cycle, I/O read cycle, I/O write cycle, or the like) is carried out.

In addition, the Register 1010 comprises a general register, a stack pointer (SP), a program counter (PC), and the like.

Further, an address controller 1011 (hereinafter, ADRC) outputs a 16-bit address.

The configuration of the processor described in this embodiment is one example and does not limit thereto. A known processor having a configuration other than the configuration described in this embodiment can be also applied.

This embodiment mode can be applied in combined with each of Embodiment Modes 1 to 6.

### Embodiment Mode 8

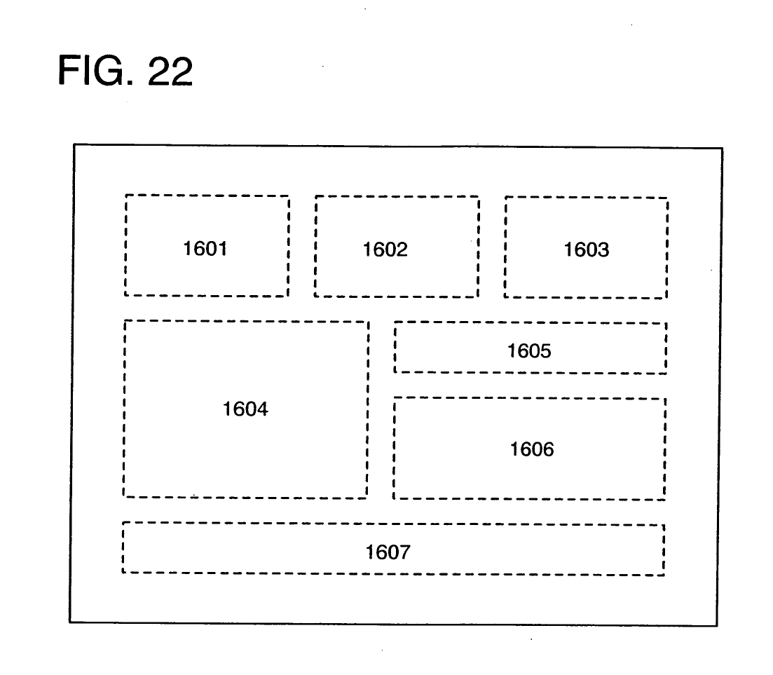

A case where the invention is applied to a system LSI which is an example of a semiconductor device is described with reference to FIG. 22.

Note that the system LSI is an LSI that is incorporated in a device having a specific application and constitutes a system for controlling the device and processing data. The application ranges widely, such as a portable phone, a PDA, a DSC, a television, a printer, a FAX, a game machine, a navigation system, a DVD player, and the like.

FIG. 22 shows an example of a system LSI. The system LSI typically includes a CPU core 1601, a nonvolatile memory (NVM) 1604, a clock controller 1603, a main memory 1602, a memory controller 1605, an interrupt controller 1606, an I/O port 1607, and the like. It is needless to say that the system LSI shown in FIG. 22 is only a simplified example and a wide variety of circuit designs are laid out according to the application of an actual system LSI.

A memory transistor manufactured in Embodiment Mode 5 can be applied to the NVM 1604.

A transistor capable of high speed operation, that is manufactured according to the invention can be used as a transistor which includes the processor core 1601, the clock controller 1603, the main memory 1602, the memory controller 1605, the interrupt controller 1606, and the I/O port 1607. This enables various circuits to be manufactured over the same substrate.

This embodiment mode can be implemented in combination with each of Embodiment Modes 1 to 7.

### Embodiment Mode 9

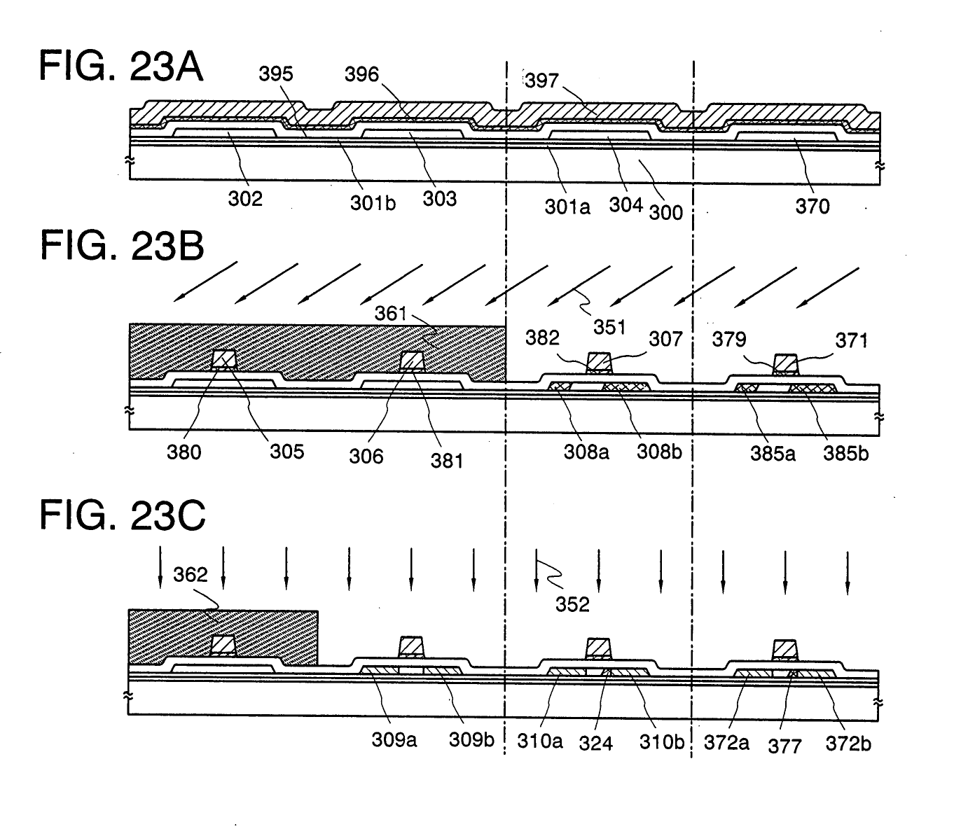

In this embodiment mode, an example having a part of a process different from the process in Embodiment Mode 3 is described with reference to FIG. 23A to 26.

As shown in Embodiment Mode 3, a base film 301a and a base film 301b are stacked as a base film over a substrate 300 and a semiconductor layer 302, a semiconductor layer 303, a semiconductor layer 304, and a semiconductor layer 370 are formed. An amorphous semiconductor film is irradiated with laser light to be crystallized, and then a formed crystalline semiconductor film is patterned to form the semiconductor layer 302, the semiconductor layer 303, the semiconductor layer 304, and the semiconductor layer 370. In this embodiment mode, a semiconductor layer comprises silicon, and a crystalline silicon film having crystal grains continuously grown is formed by irradiating an amorphous silicon film with laser light. Note that the semiconductor layer 302, the semiconductor layer 303, and the semiconductor layer 304, and the semiconductor layer 370 are formed so that channel formation regions of subsequently formed thin film transistors are formed parallel to the scanning direction of the laser light.

A gate insulating layer 395 is formed over the semiconductor layer 302, the semiconductor layer 303, the semiconductor layer 304, and the semiconductor layer 370 to form a first conductive film 396 and a second conductive film 397 (FIG. 23A). In this embodiment mode, a thin silicon oxide film of 2 to 5 nm thick is formed as a first insulating film over the semiconductor layer 302, the semiconductor layer 303, the semiconductor layer 304, and the semiconductor layer 370 by a GRTA (gas rapid thermal anneal). A lamination film of a silicon nitride film, a silicon oxide film, and a silicon nitride film are stacked over the first insulating film to be used as the gate insulating layer 395. The first conductive film 396 comprises TaN and the second conductive film 397 comprises W, by sputtering.

The first conductive film 396 and the second conductive film 397 are etched to be a thin line, thereby forming a first gate electrode layer 305, a first gate electrode layer 306, a first gate electrode layer 307, a first gate electrode layer 371, a second gate electrode layer 380, a second gate electrode layer 381, a second gate electrode layer 382, and a second gate electrode layer 379. A mask 361 comprising a resist is formed so as to cover the semiconductor layer 302 and the semiconductor layer 303, thereby forming a gate electrode layer.

The semiconductor layers are doped with an impurity element 351 imparting p-type obliquely to the surfaces thereof by the doping device shown in FIG. 1A and FIG. 1B, using the first gate electrode layer 307, the second gate electrode layer 382, the first gate electrode layer 371 and the second gate electrode layer 379 as masks, thereby forming a first p-type impurity region 308a, a first p-type impurity region 308b, a first p-type impurity region 385a, and a first p-type impurity region 385b (FIG. 23B). For simplification, a substrate which is placed horizontally is shown in FIG. 23B, doping is conducted while the substrate is inclined and moved in one direction practically. Since the semiconductor layers are doped with the impurity element 351 imparting p-type obliquely to the surfaces thereof, the first p-type impurity region 308b and the first p-type impurity region 385b are formed in the semiconductor layer 304 and the semiconductor layer 370 covered with the first gate electrode layer 307 and the first gate electrode layer 371. However, the impurity element 351 imparting p-type is blocked by the first gate electrode 307 and the first gate electrode layer 371 which function as a mask; therefore, the first p-type impurity region 308a and the first p-type impurity region 385a are not formed in the semiconductor layer 304 and the semiconductor layer 370 formed below the first gate electrode layer 307 and the first gate electrode layer 371. The doping is conducted so that the first p-type impurity region 308a, the first p-type impurity region 308b, the first p-type impurity region 385a, and the first p-type impurity region 385b include the impurity elements imparting p-type to be a concentration of approximately 5×10¹⁷ to 5×10¹⁸/cm³. In addition, the concentration thereof may be set at approximately 5×10¹⁶ to 1×10¹⁷/cm³. In this embodiment mode, boron (B) is used as the impurity element imparting p-type.

In this embodiment mode, in a thin film transistor having the semiconductor layer 304 formed later, a region where the first p-type impurity region 308b is formed is to be a drain region, and in a thin film transistor having the semiconductor layer 370, a region where the first p-type impurity region 385b is formed is to be a source region. When a channel formation region of the semiconductor layer is arranged parallel to the scanning direction of the laser light and the semiconductor layer is doped with an impurity element obliquely from one direction using the gate electrode layer as a mask, an impurity region having one conductivity different from the conductivity of the thin film transistor can be formed at only one of the source region and the drain region. According to the invention, both a thin film transistor including an impurity region having conductivity different from the conductivity of the thin film transistor in a source region and a thin film transistor including an impurity region having conductivity different from the conductivity of the thin film transistor in a drain region can be formed by the same step. It is freely configured which of the high concentration impurity regions is formed as a source region or a drain region by a wiring to be connected or the like, and the invention can be adapted to any circuit adequately. Thus, it can control properties of a thin film transistor minutely and manufacture varied thin film transistors. Therefore, a high-accuracy semiconductor device which needs a plurality of circuits having different functions can be manufactured with high reliability.

Next, the mask 361 is removed and a mask 362 comprising a resist is formed to cover the semiconductor layer 302. The mask 362 may be newly formed or may be formed by processing the mask 361. The semiconductor layer 303, the semiconductor layer 304, and the semiconductor layer 370 are doped with an impurity element imparting n-type, using the first gate electrode layer 306, the first gate electrode layer 307, and the first gate electrode layer 371 as masks perpendicularly to the surfaces thereof, thereby forming a first n-type impurity region 309a, a first n-type impurity region 309b, a first n-type impurity region 310a, a first n-type impurity region 310b, a first n-type impurity region 372a, and a first n-type impurity region 372b (FIG. 23C). The first p-type impurity region 308a, the first p-type impurity region 308b, the first p-type impurity region 385a, and the first p-type impurity region 385b have been doped with the impurity element imparting p-type; therefore, they are required to be doped with an impurity element imparting n-type in order to be changed into n-type impurity regions. The first n-type impurity region 309a, the first n-type impurity region 309b, the first n-type impurity region 310a, the first n-type impurity region 310b, the first n-type impurity region 372a, and the first n-type impurity region 372b are formed to include the impurity elements imparting n-type in a concentration of 1×10¹⁷ to 5×10¹⁸/cm³ typically. In this embodiment mode, phosphorous (P) is used as the impurity elements imparting n-type. Regions covered with the first gate electrode layer 306, the first gate electrode layer 307, and the first gate electrode layer 371 in the semiconductor layer 303, the semiconductor layer 304, and the semiconductor layer 370 are not doped with the impurity element 352. The reason is that the impurity element 352 is blocked by the first gate electrode layer 306, the first gate electrode layer 307, and the first gate electrode layer 371 since the impurity element 352 is doped perpendicularly. Therefore, parts of the first p-type impurity regions formed in the semiconductor layer that is below the first gate electrode layer 307 and the first gate electrode layer 371 are left, and become a second p-type impurity region 324 and a second p-type impurity region 377. The second p-type impurity region 324 is formed at the drain side and the second p-type impurity region 377 is formed at a source side as Lov regions.

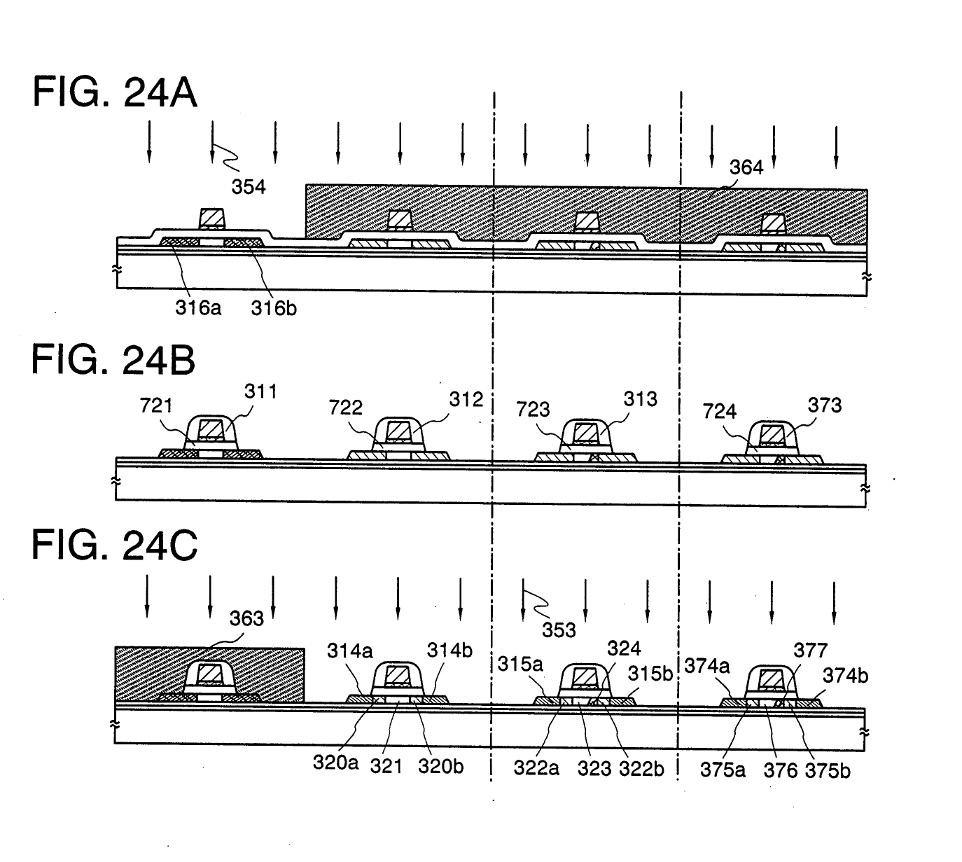

The mask 362 is removed by etching or the like, and a mask 364 comprising a resist is formed for covering the semiconductor layers 303, 304, and 370. By using the mask 364 and the first gate electrode layer 305 as the mask, the semiconductor layer 302 is doped with an impurity element 354 imparting p-type perpendicularly to the surface thereof, thereby forming a third p-type impurity region 316a and a third p-type impurity region 316b (FIG. 24A). Here, the doping is conducted so that the third p-type impurity region 316a and the third p-type impurity region 316b include the impurity element imparting p-type at a concentration of approximately 5×10¹⁸ to 5×10¹⁹/cm³. In this embodiment mode, boron (B) is used as the impurity element imparting p-type.

The mask 364 is removed by etching or the like. An insulating layer is formed over the gate insulating layer 395, the first gate electrode layer 305, the first gate electrode layer 306, the first gate electrode layer 307, and the first gate electrode layer 371, the second gate electrode layer 380, the second gate electrode layer 381, the second gate electrode layer 382, and the second gate electrode layer 379. Then anisotropic etching is conducted to form a sidewall 311, a sidewall 312, a sidewall 313, and a sidewall 373 on side surfaces of the first gate electrode layer 305, the second gate electrode layer 380, the first gate electrode layer 306, the second gate electrode layer 381, the first gate electrode layer 307, the second gate electrode layer 382, the first gate electrode layer 371, and the second gate electrode layer 379. In this embodiment, silicon oxide is used as an insulating layer for forming the side walls. When forming the side walls 311, 312, 313 and 373, the semiconductor layers 302, 303, 304 and 370 are etched as etching stoppers and exposed, thereby forming an insulating layer 721, an insulating layer 722, an insulating layer 723 and an insulating layer 724.

In this embodiment mode, when etching the insulating film, the side walls 311, 312, 313 and 373 are formed in the form so that the insulating films remain over the first gate electrode layer 305, the first gate electrode layer 306, the first gate electrode layer 307, and the first gate electrode layer 370 (FIG. 24B). Further, the insulating films are etched so that the first gate electrode layer 305, the first gate electrode layer 306, the first gate electrode layer 307, and the first gate electrode 370 are exposed. After forming the side walls, a protective film may be formed on each of the first gate electrode layer 305, the first gate electrode layer 306, the first gate electrode layer 307, and the first gate electrode layer 370. By protecting the first gate electrode layer 305, the first gate electrode layer 306, the first gate electrode layer 307, and the first gate electrode layer 370, those films can be prevented from being decreased in thickness when conducting etching process.

A mask 363 comprising a resist, for covering the semiconductor layer 302 is formed. The semiconductor layer 303, the semiconductor layer 304, and the semiconductor layer 370 are doped with an impurity element 353 imparting n-type perpendicularly to the surface thereof by using the sidewall 312, the sidewall 313, the sidewall 373, the first gate electrode layer 306, the first gate electrode layer 307, and the first gate electrode layer 371 as masks, thereby forming the second n-type impurity region 314a, the second n-type impurity region 314b, the second n-type impurity region 315a, the second n-type impurity region 315b, the second n-type impurity region 374a and the second n-type impurity region 374b (FIG. 24C). The semiconductor layers covered with sidewalls is not doped with the impurity element 353 imparting n-type, thereby being a third n-type impurity region 320a, a third n-type impurity region 320b, a third n-type impurity region 322a, a third n-type impurity region 322b, a third n-type impurity region 375a and the third n-type impurity region 375b, which are low concentration n-type regions. Note that a channel formation region 321, a channel formation region 323, and a channel formation region 376 are formed in the semiconductor layer 303, the semiconductor layer 304, and the semiconductor layer 370. Since the second n-type impurity region 314a, the second n-type impurity region 314b, the second n-type impurity region 315a, the second n-type impurity region 315b, the second n-type impurity region 374a, and the second n-type impurity region 374b are high concentration impurity region, those regions function as a source region or a drain region. In this embodiment mode, the second n-type impurity region 315b where the second p-type impurity region 324 is formed is to be a drain region, and the second n-type impurity region 374b where the second p-type impurity region 377 is formed is to be a source region. Therefore, the second n-type impurity region 315a functions as a source region, and the second n-type impurity region 374a functions as a drain region. The second n-type impurity region 314a, the second n-type impurity region 314b, the second n-type impurity region 315a, and the second n-type impurity region 315b are doped with an impurity element at the concentration of approximately 5×10¹⁹ to 5×10²⁰/cm³. In this embodiment, phosphorus (P) is used as an impurity element imparting n-type.

Alternatively, the third n-type impurity region 320a, the third n-type impurity region 320b, third n-type impurity region 322a, the third n-type impurity region 322b, the third n-type impurity region 375a and the third n-type impurity region 375b are Loff regions which are not covered with the first gate electrode layer and the second gate electrode layer, and therefore these regions can prevent degradation due to hot carrier injection by alleviating the electric field in the vicinity of the drain and have effect of reducing off current. As a result, a semiconductor device having high reliability and lower power consumption can be manufactured.

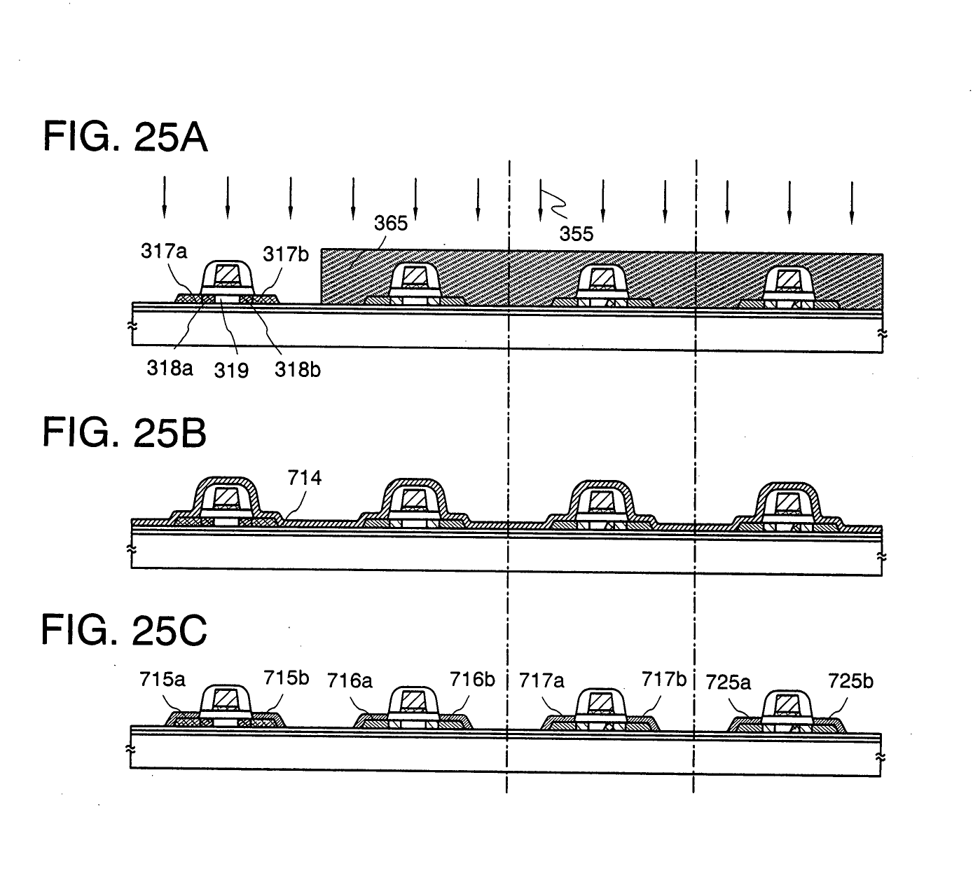

A mask 365 comprising a resist, for cover the semiconductor layer 303, the semiconductor layer 304, and the semiconductor layer 370 are formed. The mask 364 may be used as the mask 365 without removing, or the mask 364 may be processed to be used as the mask 365. Needless to say, the mask 365 is newly formed. The semiconductor layer 302 is doped with an impurity element 355 imparting p-type perpendicularly to the surface thereof by using the mask 365 and the first gate electrode layer 305 as masks, thereby forming a fourth p-type impurity region 317a, a fourth p-type impurity region 317b, a fifth p-type impurity region 318a, and a fifth p-type impurity region 318b (FIG. 25A). Here, the fourth p-type impurity region 317a and the fourth p-type impurity region 317b are doped with an impurity element imparting p-type at the concentration of approximately 1×10²⁰ to 5×10²¹/cm³. Further, the fifth p-type impurity region 318a and the fifth p-type impurity region 318b are doped with an impurity element imparting p-type at the concentration of approximately 5×10¹⁸ to 5×10¹⁹/cm³. In this embodiment mode, boron (B) is used as an impurity element imparting p-type. Note that a channel formation region 319 is formed in the semiconductor layer 302.

The fourth p-type impurity region 317a and the fourth p-type impurity region 317b are high concentration impurity regions, and function as a source region or a drain region. Furthermore, the fifth p-type impurity region 318a and the fifth impurity region 318b are low concentration impurity regions, and formed of Loff regions which are not covered with a gate electrode layer. Since the fifth p-type impurity region 318a, the fifth p-type impurity region 318b are Loff regions which are not covered with the gate electrode layer, and therefore these regions can prevent degradation due to hot carrier injection by alleviating the electric field in the vicinity of the drain and have effect of reducing off current. As a result, a semiconductor device capable of high speed operation having high reliability and low power consumption can be manufactured.

A conductive film 714 is formed over the semiconductor layer 302, the semiconductor layer 303, the semiconductor layer 304, the semiconductor layer 370, the sidewall 311, sidewall 312, sidewall 313, and the sidewall 373 (FIG. 25B). Titanium (Ti), nickel (Ni), tungsten (W), molybdenum (Mo), cobalt (Co), zirconium (Zr), Hf (hafnium), tantalum (Ta), vanadium (V), neodymium (Nb), chrome (Cr), platinum (Pt), palladium (Pd) are used as a material for forming the conductive film 714. Here, a titanium film is formed by sputtering.

The silicon in the semiconductor of exposed source region and drain region, and the conductive film 714 are reacted by heat treatment, GRTA, LRTA, or the like thereby forming a silicide 715a and silicide 715b, a silicide 716a and silicide 716b, a silicide 717a and silicide 717b, and a silicide 725a and a silicide 725b. Then, the conductive film 714 which does not react with the semiconductor layer is removed (FIG. 25C).

An insulating film 325 for hydrogenation is appropriately formed by heat treatment, laser irradiation, or the like for activating an impurity element. Hydrogenation is conducted by heat treatment, and then an insulating layer 326 is formed. The heat treatment for activating an impurity element and the heat treatment for hydrogenation may be conducted in the same process; therefore, the process can be simplified.

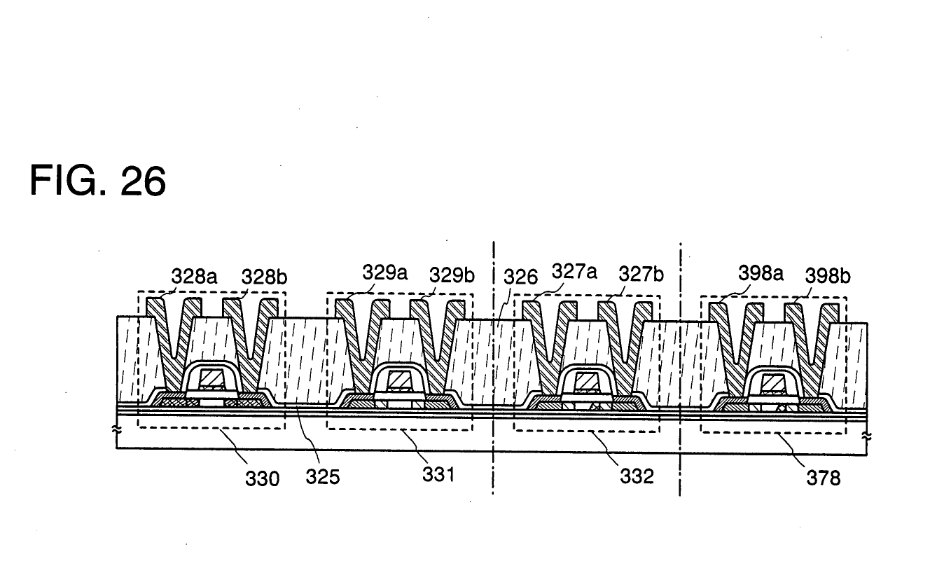

An opening portion (contact hole) reaching the source region and the drain region, is formed in the insulating layer 326 and the insulating layer 325. A source electrode layer or a drain electrode layer 328a, a source electrode layer or a drain electrode layer 328b, a source electrode layer or a drain electrode layer 329a, a source electrode layer or a drain electrode layer 329b, a source electrode layer or a drain electrode layer 327a, a source electrode layer or a drain electrode layer 327b, a source electrode layer or a drain electrode layer 398a, and a source electrode layer or a drain electrode layer 398b, each of which is in contact with the source region or the drain region are formed in each of the opening portion (FIG. 26). In this embodiment mode, the source electrode layer or the drain electrode layer 327a becomes a source electrode layer, and the source electrode layer or the drain electrode layer 327b becomes a drain electrode layer. Alternatively, the source electrode layer or the drain electrode layer 398a becomes a drain electrode layer, and the source electrode layer or the drain electrode layer 398b becomes a source electrode layer. Accordingly, a p-channel thin film transistor 330, an n-channel thin film transistor 331, an n-channel thin film transistor 332 having a low concentration p-type impurity region at its drain region, and an n-channel thin film transistor 378 having a low concentration p-type impurity region at its source region are manufactured, and a semiconductor device using these transistors are manufactured. In this embodiment mode, a CMOS circuit, and a CPU provided with a thin film transistor of which the property is controlled are manufactured over the same substrate.

Since a silicide structure is applied to the p-channel thin film transistor 330, n-channel thin film transistor 331, the n-channel thin film transistor 332 having low concentration p-type impurity region at its drain region, and the n-channel thin film transistor 378 having a low concentration p-type impurity region at its source region, the source region and the drain region can be low resistance and a semiconductor device having high speed can be obtained. Since the semiconductor device can be operated at low voltage, power consumption can be reduced.

This embodiment mode can be used by combining with any one of Embodiment Mode 1 to 7.

### Embodiment Mode 10

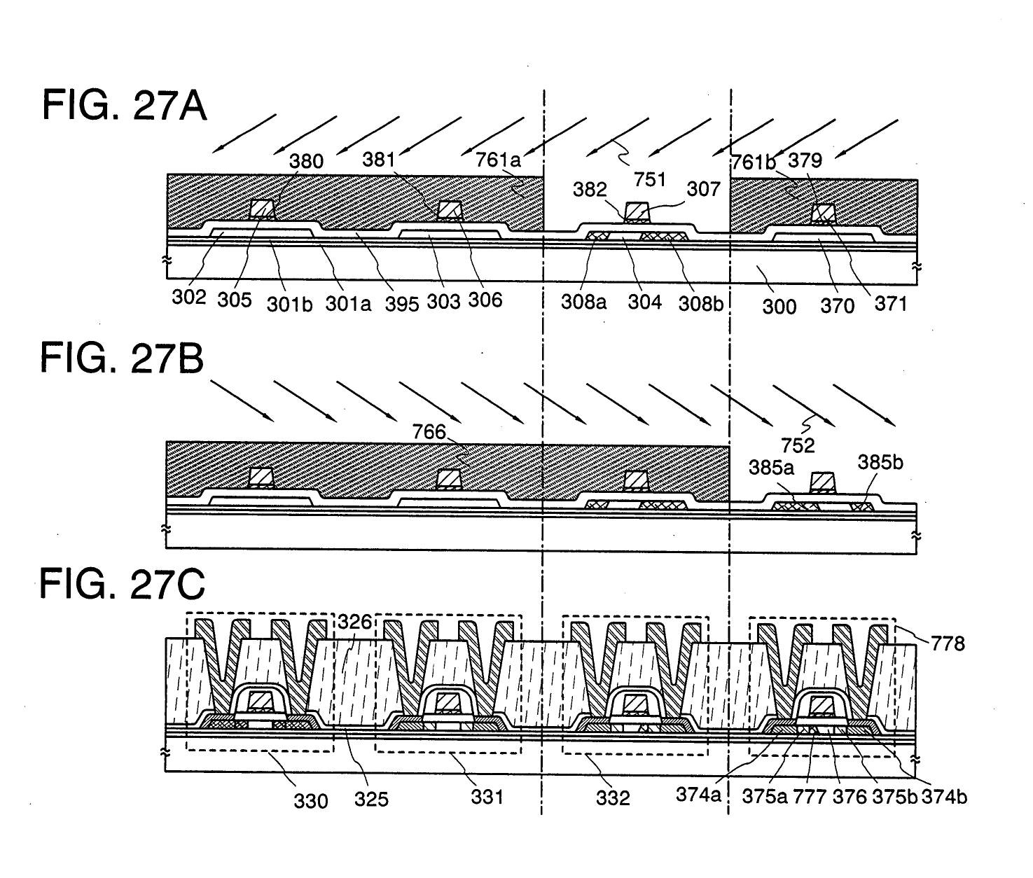

In this embodiment mode, an example where the process of Embodiment Mode 9 is partially modified is described with reference to FIGS. 27A to 27C. Note that detailed description concerning the same process as Embodiment Mode 9 is omitted.

In the process of Embodiment Mode 9 shown in FIG. 23B, an example of doping the substrate one time diagonally is shown. However, in this embodiment mode, an example of doping the substrate twice at different angles is shown.

As a substitute for the process in FIG. 23B, masks 761a and 761b comprising resists are formed as shown in FIG. 27A, and the first doping is conducted. Since the substrate is doped with an impurity element 751 imparting p-type diagonally, the first p-type impurity region 308b is formed in the semiconductor layer 304 covered with the first gate electrode layer 307. However, the impurity element 751 imparting p-type is blocked by the first gate electrode 307 which functions as a mask; therefore, the first p-type impurity region 308a is not formed in the semiconductor layer 304 formed below the semiconductor layer 307.

Then, a mask 766 comprising a resist is formed after removing the masks 761a and 761b. The mask 766 may be newly formed or formed by processing the masks 761a and 761b.

The second doping is conducted at a different angle from the first doping as shown in FIG. 27B. Since the semiconductor layer is diagonally doped with the impurity element 752 imparting p-type, the first p-type impurity region 385a is formed in the semiconductor layer 370 covered with the first gate electrode layer 371. However, the impurity element 752 imparting p-type is blocked by the first gate electrode 371 which functions as a mask, the first p-type impurity region 385b is not formed in the semiconductor layer 370 to be covered with the first gate electrode layer 371.

By conducting doping twice, the first p-type impurity region 308a, the first p-type impurity region 308b, the first p-type impurity region 385a, and the first p-type impurity region 385b are doped with an impurity element imparting p-type at the concentration of approximately 5×10¹⁷ to 5×10¹⁸/cm³, or may be doped at the concentration of approximately 5×10¹⁶ to 1×10¹⁷/cm³. In this embodiment mode, boron (B) is used as an impurity element imparting p-type.

A structure shown in the cross section of FIG. 27C is obtained in the following processes according to Embodiment Mode 9. The p-channel thin film transistor 330, the n-channel thin film transistor 331, the n-channel thin film transistor 332 having low concentration p-type impurity region at its drain region, and an n-channel thin film transistor 778 having a low concentration p-type impurity region 777 at its drain region can be formed.

This embodiment mode can be freely combined with any of Embodiment Mode 1 to 9.

### Embodiment Mode 11

A semiconductor device manufactured by using a doping device of the invention is used for various purposes. For example, an ID chip which is one mode of the semiconductor device can be used by being mounted on bills, coins, securities, documents, bearer bonds, packing cases, books, recording mediums, personal belongings, vehicles, foods, clothes, health items, livingwares, medicals, electronics devices, or the like. In addition, a processor chip can also be used instead of an ID chip.

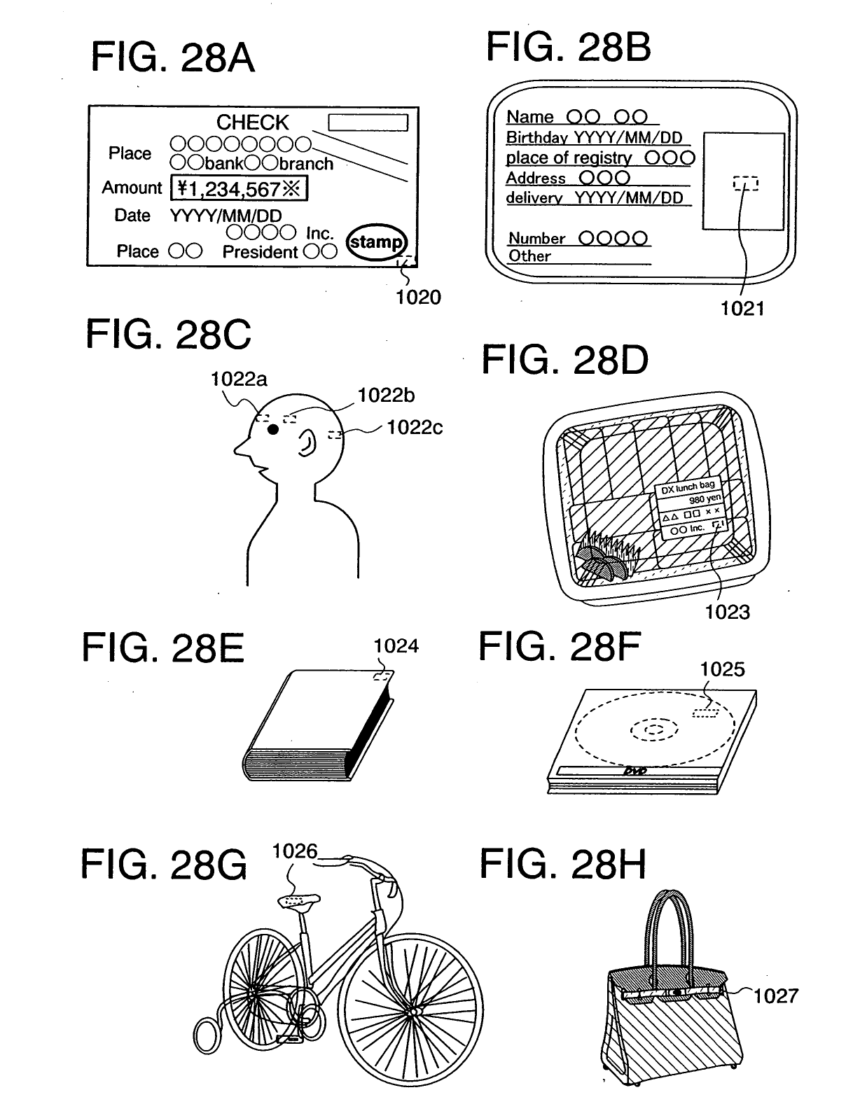

The bills and the coins mean currency in the market and include a thing that is used in the same way as a currency in a specific area (a cash voucher), memorial coins, and the like. The securities mean a check, a stock certificate, a promissory bill, and the like and can be provided with an ID chip 1020 (FIG. 28A). The certificates mean a driver's license, a resident card, and the like and can be provided with an ID chip 1021 (FIG. 28B). The bearer bonds mean a stamp, a coupon for rice, various gift coupons, and the like. The packing cases mean a wrapping paper for a lunch box or the like, a plastic bottle, and the like and can be provided with an ID chip 1023 (FIG. 28D). The books mean a book, a volume, and the like and can be provided with an ID chip 1024 (FIG. 28E). The recording medium means DVD software, a video tape, and the like and can be provided with an ID chip 1025 (FIG. 28F). The personal belongings mean a bag, glasses, and the like and can be provided with an ID chip 1027 (FIG. 28H). The vehicles mean a wheeled vehicle such as a bicycle, a vessel, and the like and can be provided with an ID chip 1026 (FIG. 28G). The foods mean eatables, beverages, and the like. The clothes mean wear, footwear, and the like. The health items mean medical devices, health appliances, and the like. The livingwares mean furniture, a lighting apparatus, and the like. The medicals mean medicines, agricultural chemicals, and the like. The electronic devices mean a liquid crystal display device, an EL display device, a television apparatus (a TV set and a thin television set), a cellular phone, and the like.

When an ID chip is mounted on the bills, the coins, the securities, the documents, the bearer bonds, and the like, counterfeiting thereof can be prevented. When an ID chip is mounted on the packing cases, the books, the recording medium, the personal belongings, the foods, the living wares, the electronic devices, and the like, the efficiency of the inspection system, the rental system, and the like can be improved. When an ID chip is mounted on the vehicles, the health items, the medicals, and the like, counterfeiting and theft thereof can be prevented and the medicines can be prevented from being taken in the wrong manner. The ID chip may be attached to a surface of a product or mounted inside a product. For example, the ID chip may be mounted inside a paper of a book, or mounted inside an organic resin of a package.

A processor chip can be used as a device for measuring evaluation on biological reaction of beings (a biological signal (a brain wave, electrocardiogram, electromyogram, blood pressure, or the like)), thus, it can be used in a medical field. FIG. 28C shows an example where a brain wave is measured by mounting a plurality of processor chips on a human body. The brain wave is measured by analyzing information obtained from a processor chip 1022a, a processor chip 1022b, and a processor chip 1022c which are mounted on a human body. A physical health condition and a mental condition can be known by information obtained from the brain wave and the processor chip. Additionally, a processor chip is small size and lightweight; therefore, it can cut down on a burden of an examinee.

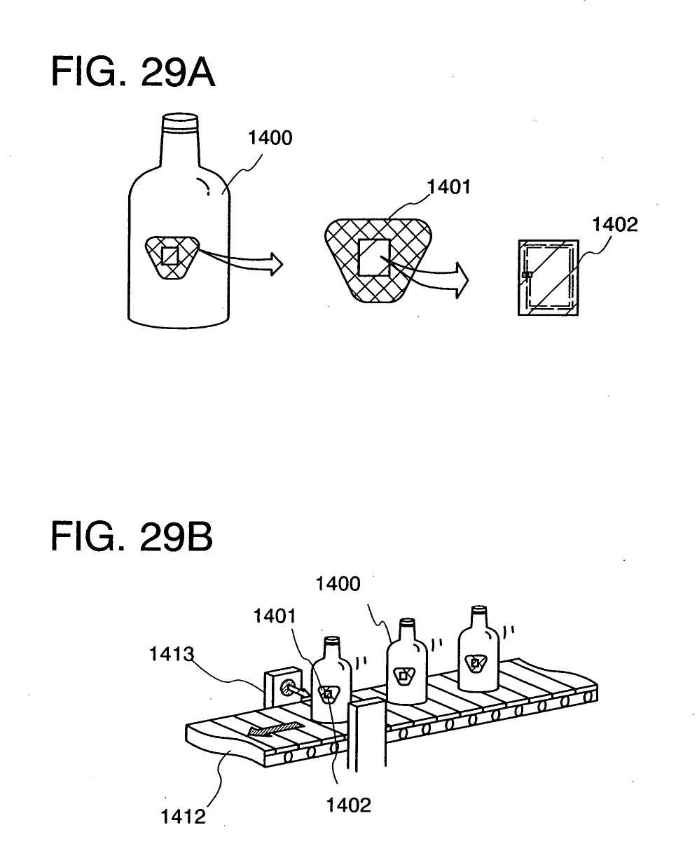

An example where the processor chip can be applied to material management and a distribution system is described with reference to FIGS. 29A and 29B. Here, a case where an ID chip (processor chip) is mounted on merchandise is explained. As shown in FIG. 29A, an ID chip 1402 is mounted on a label 1401 of a beer bottle 1400.

The ID chip 1402 stores basic points such as date manufactured, a manufacturing place, and a material thereof. Such basic points are not required to be rewritten, thus, it is preferable to use a memory medium which is not capable of being rewritten, such as a mask ROM or a memory transistor to store them. In addition, the ID chip 1402 stores individual points such as a delivery address and delivery date and time, or the like of the beer bottle. For example, as shown in FIG. 29B, the delivery address and the delivery date and time can be stored, when the beer bottle 1400 passes through a writer device 1413 with a flow of a belt conveyor 1412. Such individual points may be stored in a memory medium which is capable of being rewritten and cleared, such as an EEROM.

In addition, a system is preferably built so that when data on the merchandise purchased is sent from a delivery address to a physical distribution management center through network, a writer device, a personal computer for controlling the writer device, or the like calculates a delivery address and delivery date and time to store in the ID chip.

Note that a beer bottle is delivered per case. In view of this, it is possible that an ID chip is mounted per case or per a plurality of cases to store an individual point.

As for such merchandise stored several delivery addresses, time required for inputting manually can be suppressed, thereby input miss due to the manual procedures can be reduced, by mounting an ID chip. In addition to this, manpower cost that is the most expensive in the field of the physical distribution management can be reduced. Accordingly, physical distribution management can be conducted with less miss at low cost by mounting an ID chip.

In addition, applied points such as grocery matched with a beer and a recipe using beer can be stored by a receiver. Then, advertisements of the grocery and the like can be carried out, which can drive the consumers to buy. Such an applied point may be preferably stored in a memory medium which is capable of being rewritten and cleared, such as an EEROM. By mounting an ID chip as described above, the volume of information for being provided for a consumer can be increased, so that the consumer can purchase the merchandise without anxiety.

This embodiment mode can be freely combined with any one of Embodiment mode 1 to 10.

### INDUSTRIAL APPLICABILITY

According to the present invention, a doping device for uniformly doping a large area substrate capable of multiple patterns for the purpose of mass-production, with an impurity element can be realized and processing time for a doping process can be shortened.

1. A doping device comprising:
means for generating an ion current in which a cross section in a direction perpendicular to a flow direction of the ion current is a linear shape or a rectangle;
means for irradiating a substrate with the ion current; and
substrate position control means for moving the substrate in one direction while holding the substrate at an inclined position to a perpendicular,
wherein the ion current is irradiated to the moving substrate at the inclined position.

2. A doping device comprising:
a substrate carry-in chamber;
a substrate carry-out chamber;
a doping chamber, the doping chamber comprising:
means for generating an ion current in which a cross section in a direction perpendicular to a flow direction of the ion current is a linear shape or a rectangle; and
substrate position control means for moving a substrate in one direction while holding the substrate at an inclined position to a perpendicular,
wherein the substrate carry-in chamber, the doping chamber and the substrate carry-out chamber are arranged in series, and
wherein the ion current is irradiated to the substrate which passes through the doping chamber from the substrate carry-in chamber and moves to the substrate carry-out chamber in one direction.

3. A doping device comprising:
a substrate carry-in chamber;
a substrate carry-out chamber;
a doping chamber, the doping chamber comprising:
a first means for generating a first ion current in which a cross section in a direction perpendicular to a flow direction of the first ion current is a linear shape or a rectangle;
a second means for generating a second ion current in which a cross section in a direction perpendicular to a flow direction of the second ion current is a linear shape or a rectangle; and
substrate position control means for moving a substrate in one direction while holding the substrate at an inclined position to a perpendicular,
wherein the substrate carry-in chamber, the doping chamber and the substrate carry-out chamber are arranged in series, and
wherein the first and the second a plurality of ion currents is irradiated to the substrate which passes through the doping chamber from the substrate carry-in chamber and moves to the substrate carry-out chamber in one direction.

4. A doping device according to claim 1, further comprising:
means for heating the substrate.

5. A doping device according to claim 2, further comprising:
means for heating the substrate.

6. A doping device according to claim 3, further comprising:
means for heating the substrate.

7. A doping device according to claim 1, wherein the means for generating the ion current includes radio-frequency energy, or a microwave and a magnetic field.

8. A doping device according to claim 2, wherein the means for generating the ion current includes radio-frequency energy, or a microwave and a magnetic field.

9. A doping device according to claim 3, wherein the first means for generating the first ion current and the second means for generating the second ion current includes radio-frequency energy, or a microwave and a magnetic field.

10. A doping device according to claim 1, wherein the substrate at the inclined position is moved in a direction perpendicular to an inclined direction of the substrate.

11. A doping device according to claim 2, wherein the substrate at the inclined position is moved in a direction perpendicular to an inclined direction of the substrate.

12. A doping device according to claim 3, wherein the substrate at the inclined position is moved in a direction perpendicular to an inclined direction of the substrate.

13. A doping device according to claim 1, wherein the substrate at the inclined position is inclined parallel to one side of the substrate and using a line passing through a center of the substrate as an axis.

14. A doping device according to claim 2, wherein the substrate at the inclined position is inclined parallel to one side of the substrate and using a line passing through a center of the substrate as an axis.

15. A doping device according to claim 3, wherein the substrate at the inclined position is inclined parallel to one side of the substrate and using a line passing through a center of the substrate as an axis.

16. A doping device according to claim 1, wherein the substrate at the inclined position is inclined using a plurality of axes.

17. A doping device according to claim 2, wherein the substrate at the inclined position is inclined using a plurality of axes.

18. A doping device according to claim 3, wherein the substrate at the inclined position is inclined using a plurality of axes.

19. A doping device comprising:
an ion source;
an acceleration electrode portion;
a doping chamber for irradiating a substrate with an ion current accelerated by an electric field of the acceleration electrode portion;
a substrate stage for holding the substrate; and
a substrate control mechanism for controlling a tilt angle of the substrate stage.
